(19) United States
(12) Patent Application Publication
(10) Pub. No.: US 2011/0161155 A1
(43) Pub. Date: Jun. 30, 2011

(54) SYSTEM AND METHOD FOR FACILITATING DEBT REDUCTION

(76) Inventors: Lisa Wilhelm, Corte Madera, CA (US); Leslie Michelassi, Seattle, WA (US)

(21) Appl. No.: 12/980,811

(22) Filed: Dec. 29, 2010

Related U.S. Application Data
(60) Provisional application No. 61/291,127, filed on Dec. 30, 2009.

(51) Int. Cl. G06Q 30/00

(52) U.S. Cl. 705/14.27

(57) ABSTRACT

A system, method and computer-readable medium for providing a program featuring the re-purposing of consumer assets in a manner which allows the consumer to satisfy existing debt obligations in place with one or more creditors. The system, method and computer-readable medium re-purposes a different set of consumer assets—monthly debt payment savings, consumer necessity buying power, and previously untapped non-dollar assets- to repay creditor debts with a highly affordable and positive consumer solution that frees up cash flow for household necessity shopping and other needs. The system, method and computer-readable medium facilitate the creation of closed loop local market networks that expand to a national network of local market networks that enable consumers to affordably repay delinquent unsecured debts to creditors, including 90+ day delinquent debt.

### CROSS-REFERENCE TO RELATED APPLICATION

This application claims the benefit of U.S. Provisional Application No. 61/291,127, titled “System and Method for Facilitating Debt Reduction”, filed on Dec. 30, 2009. U.S. Provisional Application No. 61/291,127 is hereby incorporated by reference herein.

### FIELD OF THE INVENTION

The present invention relates generally to payment processing and management, and, more particularly, to a system and method for administering and managing a vendor and buyer invoicing and payment process in a vendor contract compliant manner.

### BACKGROUND OF THE INVENTION

In today's world, the collections industry, including over 5,000 collection agencies, creditor internal collections shops, 2000 debt settlement agencies, and over 300 credit counseling firms, see distressed consumers in terms of how much and how fast can they collect/recover from consumer deposit balances and earnings until the consumer's resources are exhausted or the consumer files for bankruptcy. Currently, the industry produces marginal returns for creditors and high dissatisfaction for consumers, and, with the economic crisis and escalating losses for creditors, the returns are increasingly marginal and consumer dissatisfaction is accelerating.

In the current economy, the economic crisis has cause consumers to struggle to afford basic living expenses while paying back their credit card and other unsecured loan debts. Consumers face a jobless recovery, with un-and-under employment rising to a 26-year high of 17.5%, or more than one out of every six workers, in 2009. Loss of employment, crushing debt burdens from decades of overspending and easy credit, the absence of lifelines of credit and home equity, and rising house payments on adjustable rate mortgages are forcing more and more consumers to make choices between necessity purchases and meeting debt obligations. As consumers miss payments to be able to afford basic household living expenses, collections calls escalate, and penalty fees and interest rate hikes add to the balance every month, driving up their minimum payments. Consumers caught in this never-ending debt trap watch recovery slip further and further out of reach. Many consumers feel like bankruptcy is the only way out, despite the long-term negative consequences. In today's economic climate, consumers are trying to meet increasing obligations with less and less income or other assets.

The existing situation has resulted in creditor unsecured consumer debt losses and late stage delinquency collection expenses arising from credit card, student, medical, phone, and other debt. In particular, credit card debt represents over 80% of all unsecured delinquent and charged off consumer debt placed with collection agencies. Credit card delinquencies and losses have risen to record highs (e.g., in 2009, approximately 23 million consumers became 90+ days delinquent on one or more credit cards, generating an all time high of over $90B in losses.). Moreover, there has been a 10.9% decline in retail sales since 2007, fueled by a steep downward trend in discretionary spending that has outpaced a modest uptick in necessity spending.

Conventional collections market alternatives are designed to go after consumer deposit balances, future earnings, and other assets to satisfy a consumer's outstanding debt. However, existing methods of collection exacerbate the problem and fail to address the vicious cycle of the consumer debt trap—frequently resulting in consumer bankruptcy, a clear lose/lose proposition for the consumer and the creditors.

Therefore, there is a need in the art for an innovative framework for re-purposing assets that allows a consumer to re-pay their existing debt while maintaining the ability to make necessary expenditures and avoid bankruptcy.

### SUMMARY OF THE INVENTION

The present application describes embodiments of a system, method and computer readable medium which provides for a novel program featuring the re-purposing of consumer assets in a manner which allows the consumer to satisfy existing debt obligations in place with one or more creditors and/or redirects consolidated consumers assets towards any other purposes as deemed desirable and selectable by the consumer, such as, for example, bill payment, savings, money transfer, investments or other suitable need. According to embodiments of the present invention, the system, method and computer readable medium utilizes a Consumer Asset Re-Purposing Engine (CARE) to efficiently and effectively manage an environment comprising creditors (also referred to as “CARE creditors”), the creditors' struggling consumers (also referred to as “consumers” or “CARE consumers”) and their supporters, and necessity spend category retailers (also referred to as “CARE retailers”). As used herein, the term “consumer” or “CARE consumer” is intended to mean any person who is eligible for, and elects to participate in the CARE program/system for the purpose of debt repayment. As used herein, the term “supporter” is intended to mean any person, including by not limited to, the friends and family members of the consumer, who wishes to participate in the creation of rewards via spending with participating retailers for the purpose of repurposing those rewards for the debt repayment of the consumer.

The CARE system facilitates the creation of closed loop local market networks that expand to a national network of local CARE market networks that enable consumers to affordably repay delinquent unsecured debts to creditors, including 90+ day delinquent debt. Through its engine of local market networks, the CARE system harnesses, blends, and re-purposes a different set of consumer assets—monthly debt payment savings, consumer necessity buying power, and previously untapped non-dollar assets which CARE collects and monetizes—to repay creditor debts with a highly affordable and positive consumer solution that frees up cash flow for household necessity shopping and other needs. As used herein, the term “asset” or “consumer asset” is intended to include, but is not limited to, any dollar denominated asset or non-dollar denominated asset which can be settled into a dollar amount, such as, for example, rewards for participating in a retailer network, air miles, barter credits or other asset the consumer may wish to monetize and collect for the purpose of debt repayment.

According to an embodiment of the present invention, the CARE systems allows for the creation of accounts for creditors' consumers (herein referred to as “CARE Consumer Transaction Accounts”) establishing a minimum spend amount (e.g., required minimum monthly necessity spending) with CARE retailers resulting in the earning of rewards. The earned rewards may then be combined with a partial debt payment made by the consumer (i.e., a relative small monthly payment) to generate an enhanced payment amount. Distinctly different from other collections market alternatives, which go after consumer deposit balances, future earnings, and other assets, the CARE system facilitates the establishment of a debt settlement amount between the consumer and the creditor which results in substantially lower periodic (e.g., monthly) partial debt payments, freezes/stops collections and escalating fees, and allows consumers to invite their supporters (e.g., their family/friends) into the CARE program to accelerate creditor debt repayments, effectively addressing the vicious cycle of the consumer debt trap. As consumers regain their financial footing, the CARE system lets consumers and supporters re-purpose their assets accumulated via the CARE system (i.e., the CARE accumulated assets) that are in excess of creditor debt obligations and apply these excess assets to bill payments, savings, investments, charitable donations, and other financial needs and goals.

According to embodiments of the present invention, from a creditor perspective, the CARE system collects/recovers substantially more net dollars on 90+ delinquent unsecured consumer debt and delivers a significantly improved net present value on those dollars compared to other market solutions. According to embodiments of the present invention, from a retailer perspective, the CARE system redirects a new source of consumers with repeat required periodic (e.g., monthly) necessity spending levels to participating CARE retailers over an extended time period (e.g., a 3 year period), creating the potential for the delivery of billions of dollars in captive consumer spending each year. In return for harnessing and delivering CARE consumers' captive buying power to CARE necessity spend category retailers, these CARE retailers provide, via the CARE system, substantial spending rewards that the CARE system re-purposes to pay down consumers' debts to creditors. The earned rewards represent an asset that may be applied by the consumer toward the debt settlement amount.

According to an embodiment of the present invention, the CARE system connects creditors; retailers, and struggling consumers together in a manner designed to solve the consumer debt trap for struggling consumers and improve the delinquency/loss problem for creditors. The CARE system creates a “rewards” program whereby the CARE retailers provide rewards to the CARE consumers, in exchange for the coupling of those CARE consumers with the CARE retailers for the consumers' necessity spending/purchases. The earned rewards may be combined or blended with the partial debt payment to generate an enhanced payment amount that is provided to the creditor. Accordingly, the CARE system t harnesses the earned rewards on the buying power of and previously untapped non-dollar assets it collects and monetizes for underserved consumers and re-purposes them for debt re-payment to creditors and other consumer financial needs. In this regard, the CARE system delivers substantial, captive, repeat consumer spending to the network of CARE retailers, who in turn, provide CARE with substantial spending rewards that power the CARE system's asset re-purposing debt repayment engine.

According to an embodiment of the present invention, the CARE system combines CARE creditors, CARE consumers and their supporters, and CARE necessity spend category retailers into closed loop local market networks that expand to a national network of local CARE market networks. The CARE system provides specialized support for struggling consumers including proactive out-reach to keep consumers on track/motivated during the program life cycle. The CARE system alleviates the typical creditor expenses associated with managing the segment of consumers who will not realistically be viable new revenue prospects until several years in the future.

Embodiments of the present invention provide multiple benefits to consumers, creditors, and retailers. From a consumer perspective, the CARE system coordinates with a creditor to facilitate agreement upon a reduced settlement amount with the creditor, whereby the creditor stops collections and transfers the management of the consumer-creditor account to the CARE system. Advantageously, according to this embodiment of the present invention, the monthly payment on the 90+ delinquent/charged account is significantly reduced and penalty fees and rate increases cease; thereby freeing up the consumer's cash flow.

According to an embodiment of the present invention, the CARE system establishes a Consumer Transaction Account and instructs the consumer on funding his or her monthly spending commitment and payments. The consumer then starts earning rewards by doing his/her necessity spending with the Consumer Transaction Account at retailers in the CARE network (i.e a network of retailers that are participating in the CARE system).

According to an embodiment of the present invention, the consumer may make partial debt payments (e.g., periodic payments, such as monthly) of an agreed up amount to the creditor through the CARE system. The CARE system may then combine these payments with rewards earned during the month from spending on the Consumer Transaction Account in the CARE network and any other assets collected and monetized to generate the enhanced payment amount. The enhanced payment amount (i.e., the combined assets) is forwarded as a payment to the consumer's creditor and may be comprised of any blend of rewards and consumer payment for each CARE consumer.

According to an embodiment of the present invention, from a creditor perspective, the CARE system may manage consumer/creditor accounts resulting in better recovery for the creditor (i.e., a creditor may recover more net dollars than they would normally collect from other alternatives as well as a substantially higher net present value over all other collections alternatives). Optionally, the creditor may regularly report CARE payments to credit bureaus and/or, within regulatory constraints, re-age delinquent loans after a period of consistent CARE payments, thereby assisting cardholders with long term credit repair. In addition, once final payment is received on the negotiated settlements, creditors may follow their own policies for final credit reporting for the debt settlement repayment. In this regard, creditors create goodwill with consumers as well as with regulators by reaching out to assist struggling consumers.

In addition, retailers benefit from their participation in the CARE network by receiving a long-term captive buying group (i.e., the participating consumers) having a high spending commitment on a monthly basis in exchange for the retailer's provisioning of purchase-driven rewards.

### BRIEF DESCRIPTION OF THE DRAWINGS

The present invention will be more readily understood from the detailed description of exemplary embodiments presented below considered in conjunction with the attached drawings, of which:

FIG. 1 illustrates exemplary embodiments of the Consumer Asset Re-Purposing Engine (CARE) system and related functionality, according to embodiments of the present invention;

FIG. 2 illustrates a creditor perspective of an exemplary CARE system and related processing, according to one or more embodiments of the present invention;

FIG. 3 illustrates a retailer perspective of an exemplary CARE system and related processing, according to one or more embodiments of the present invention;

FIG. 4 illustrates a consumer perspective of an exemplary CARE system and related processing, according to embodiments of the present invention;

FIG. 5 illustrates an exemplary customer relationship management (CRM) and business intelligence analytics engine and corresponding third party information and tools, derivative products, and exemplary new markets, according to embodiments of the present invention;

FIG. 6 illustrates an exemplary CARE system and related process flow, according to one or more embodiments of the present invention;

FIG. 7 illustrates an exemplary debt purchase embodiment of the present invention; and

FIG. 8 illustrates an exemplary consumer direct and partner consumer acquisition embodiment of the CARE system.

It is to be understood that the attached drawings are for purposes of illustrating the concepts of the invention and may not be to scale.

### DETAILED DESCRIPTION OF THE INVENTION

The present invention relates to a system, method, and computer readable medium for re-purposing a different set of consumer assets—monthly debt payment savings, consumer necessity buying power, and previously untapped non-dollar assets. The present invention provides for a Consumer Asset Re-Purposing Engine (CARE) system and related method (also referred to herein as the “CARE System”) comprises one or more computer devices configured to collect and monetize consumer debt to repay creditor debts with a highly affordable and positive consumer solution, while freeing up cash flow for household necessity shopping and other needs.

The term “computer device”, as used herein, is not limited to any one particular type of hardware device, but may be any data processing device such as a desktop computer, a laptop computer, a kiosk terminal, a personal digital assistant (PDA) or any equivalents or combinations thereof. Any device or part of a device configured to process, manage or transmit data, whether implemented with electrical, magnetic, optical, biological components or otherwise, may be made suitable for implementing the invention described herein. Similarly, the term “communication device”, as used herein, is not limited to any one particular type of hardware device, but may be any device enabled for communication with an established network such as, for example, a local area network, a wide area network, a telephone network, a cable television network, an intranet, the Internet, or any other suitable wired or wireless communications network.

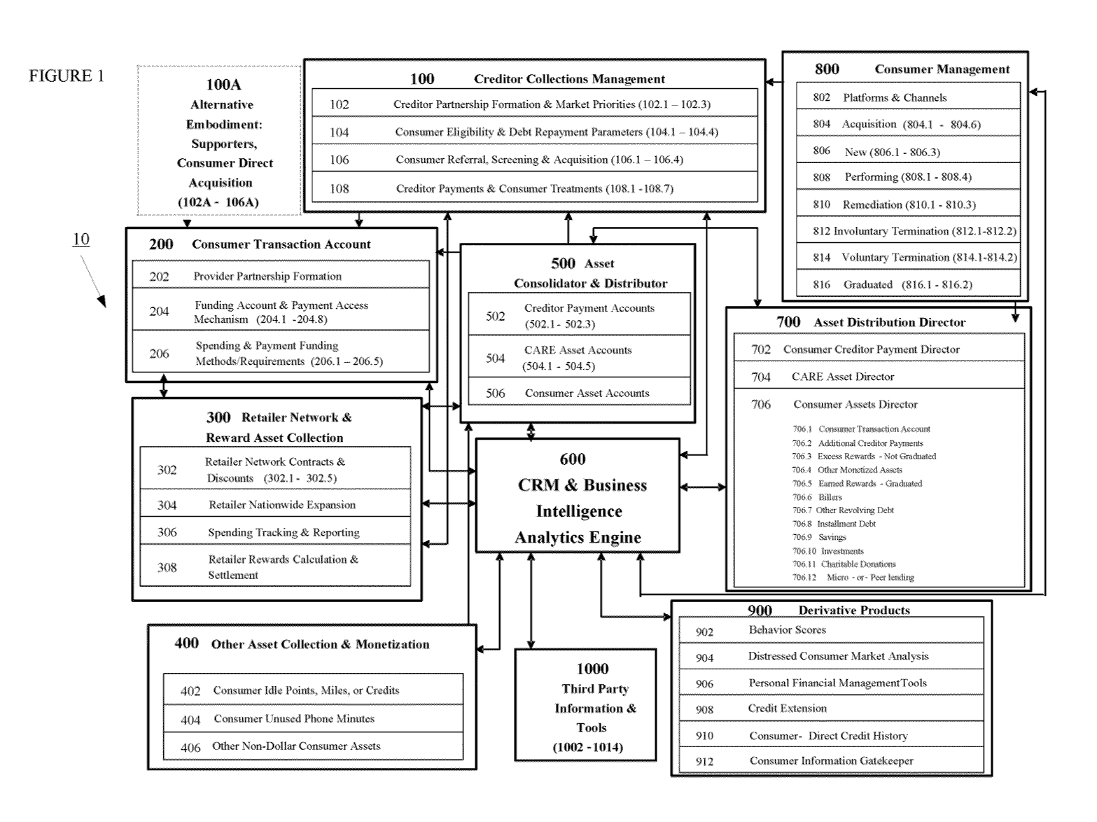

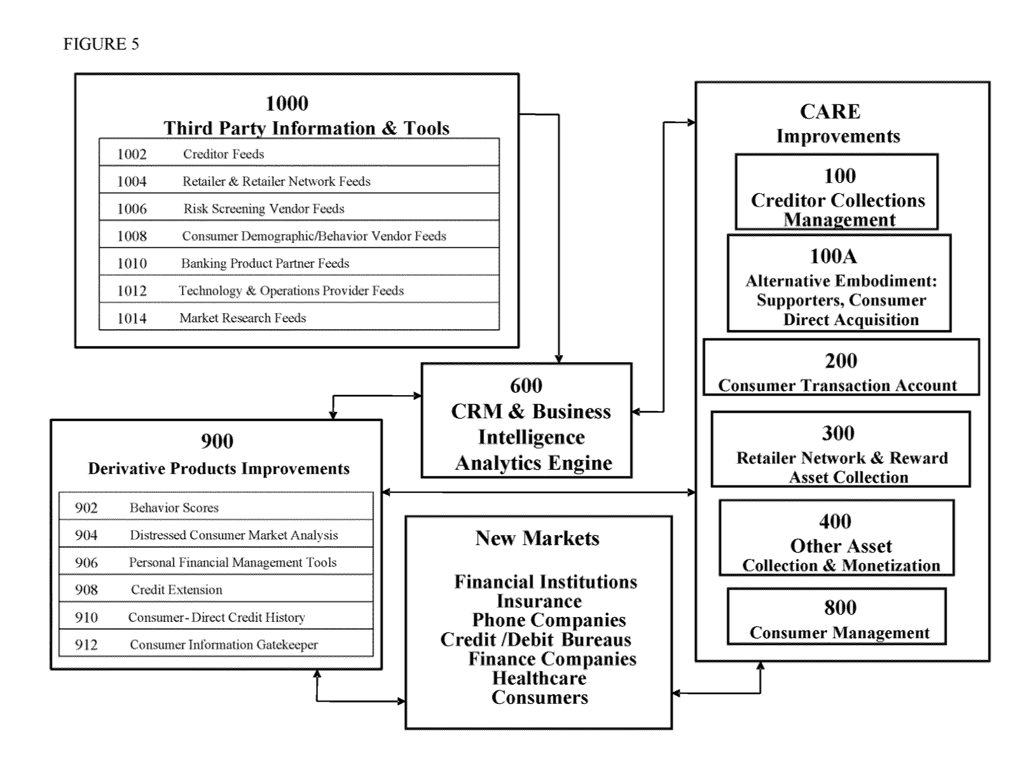

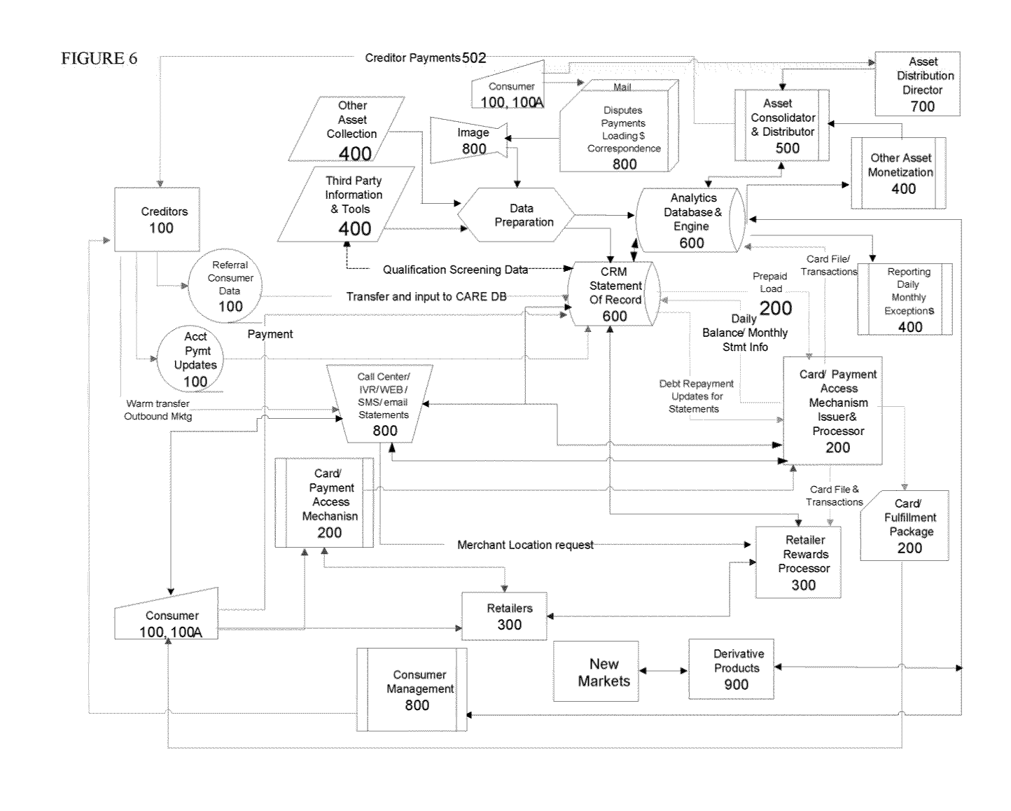

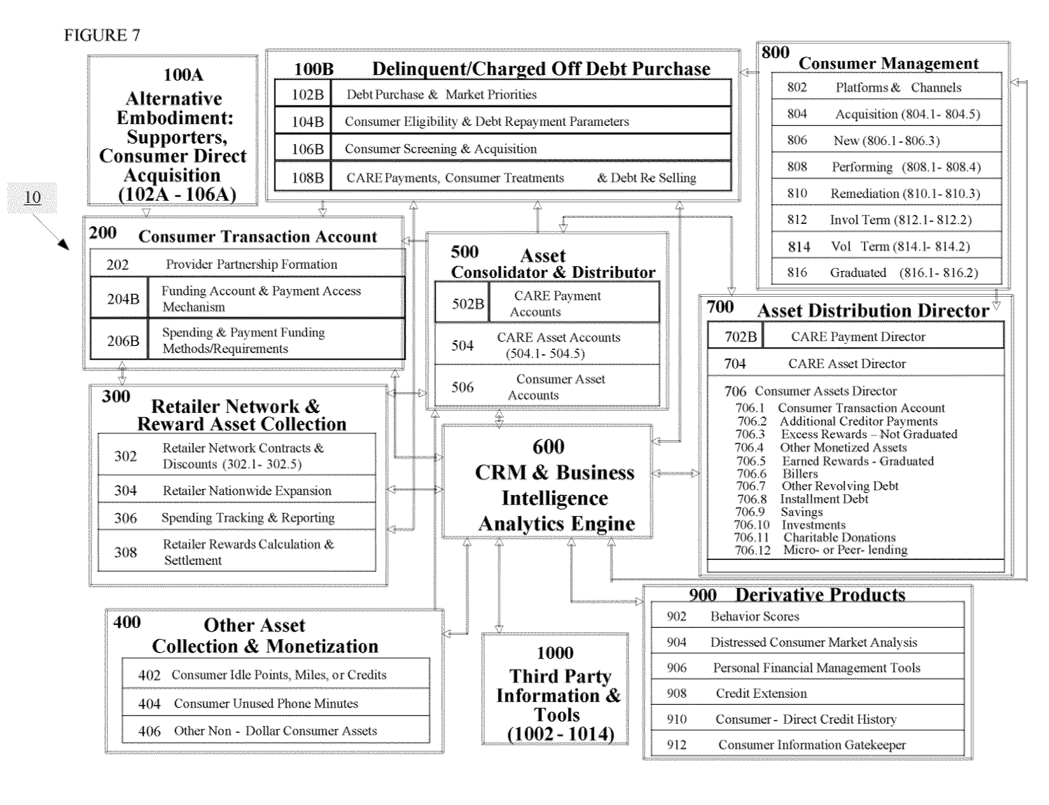

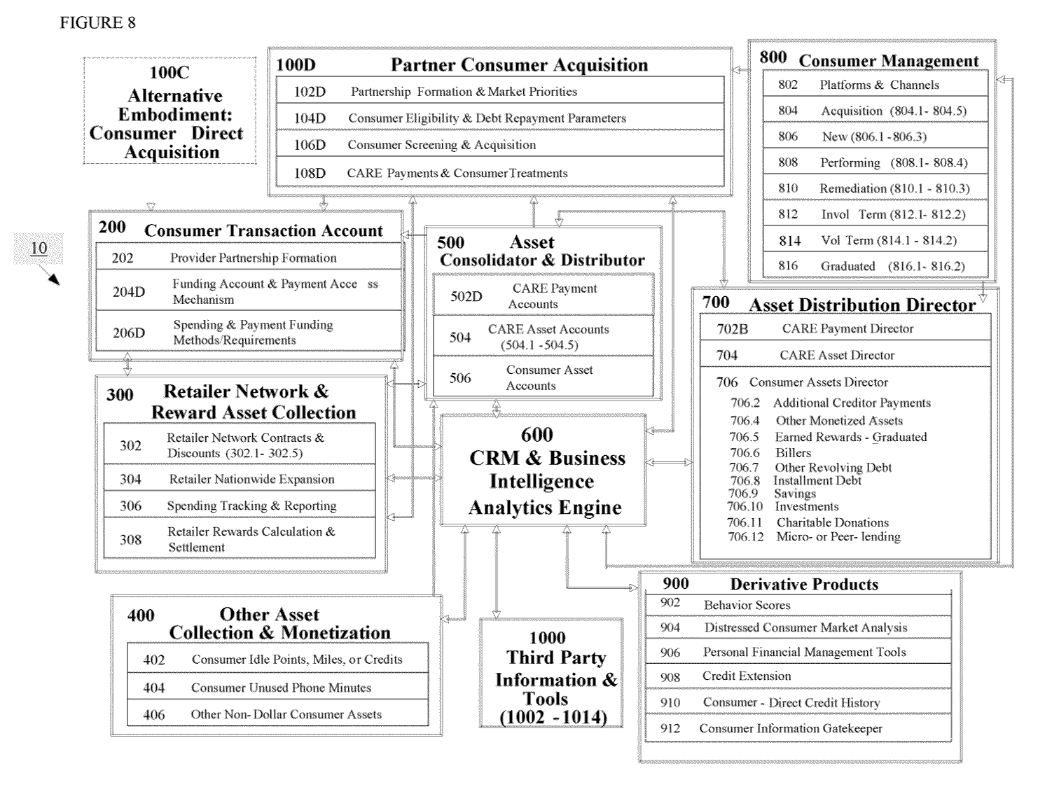

FIGS. 1-8 present multiple embodiments of the CARE System 10, as described in detail below. The CARE System 10 comprises one or more computer modules including one or more computer programmed processes and/or instructions directed at managing various aspects and stages of the asset re-purposing process. One having ordinary skill in the art will appreciate that the computer modules described in connection with each of FIGS. 1-8 may comprise a computer device programmed to implement various processes and functionality as described in detail below in connection with each of the illustrated embodiments. The computer modules may reside on and be deployed through a wide variety of computing devices and platforms. Such devices and platforms may include a special purpose computer, a computer system including a microcomputer, a mini-computer or mainframe for example, a programmed microprocessor, a micro-controller, a peripheral integrated circuit element, a CSIC (Consumer Specific Integrated Circuit) or ASIC (Application Specific Integrated Circuit) or another suitable integrated circuit, a logic circuit, a digital signal processor, a programmable logic device such as a FPGA, PLD, PLA or PAL, or any other device or arrangement of devices that is capable of implementing the steps deployed for enabling the fund remittance process described herein.

As shown in FIGS. 1-8, the CARE System 10 comprises a plurality of modules and sub-modules (collectively, the computer modules). The computer modules are configured to implement various instructions and processes related to embodiments of the asset re-purposing method and system of the present invention. The processes and/or instructions associated with the asset re-purposing system described herein may be presented in one or more programs that are executable, for example, by a computer device. Software packages may also be provided, wherein a collection of separate programs, a program module within a larger program, a portion of a program module or any other conceivable combinations thereof is presented. The software used might also include modular programming in the form of object oriented programming, wherein the software provides instructions to one or more computer devices for how to handle a particular set of data to be processed.

The CARE System 10 may be comprised of any combination of systems and sub-systems such as electronic devices including, but not limited to, computers, servers, databases, or the like. The electronic devices may include any combination of hardware components such as processors, databases, storage drives, registers, cache, random access memory (RAM) chips, data buses, or the like and/or software components such as operating systems, database management applications, or the like.

The term “computer” is intended to include any data processing device, such as a desktop computer, a laptop computer, a mainframe computer, a personal digital assistant, a server, a handheld device, or any other device able to process data. Although the present application describes the PKM protocol primarily in the context of the management of financial-based transactions, one having ordinary skill in the art will appreciate that the PKM protocol may be used for securing any type of transaction, particularly those including sensitive data, such as, for example, a health care related transaction over a health care network

The CARE System 10 is configured to implement a CARE program designed to uniquely combine creditors (also referred to herein as “CARE creditors”), creditors' struggling consumers (also referred to herein as “CARE consumers”) and their family/friends or un-related third parties (herein the “supporters”), and necessity spend category retailers (also referred to herein as “CARE retailers”) into closed loop local market networks (also referred to as “local CARE market networks”) that expand to a national network of local CARE market networks that enable consumers to affordably repay delinquent unsecured debts to creditors (e.g., 90+ day debts).

Embodiments of the present invention address three very large and inter-related market pain points simultaneously. Specifically, the CARE System 10 combines CARE creditors, CARE creditors' struggling consumers, and CARE necessity spend category retailers into a closed loop network on a local market basis that expands to a national network of local CARE market networks to solve for these pain points.

First, the CARE System 10 helps a growing number of consumers who are struggling to afford both basic living expenses and paying their credit card and other unsecured loan debts. For struggling consumers, the CARE System 10 provides a highly affordable way out of their consumer debt traps. The CARE System 10 reduces the total debt consumers must repay by coordinating with the creditor(s) to establish a debt settlement amount; substantially lowers monthly payments; uniquely harnesses and re-purposes monthly payment savings associated with the consumer having to make the partial debt payment, necessity spending rewards, and other consumer assets to pay down debt; stops collections and escalating fees; and provides cash incentives for staying on track. As used herein, the term “debt settlement amount” is intended to include, but is not limited to, a settlement or agreement between a consumer and a creditor for an amount to be paid in satisfaction of the original debt, and is generally a reduced amount relative to the original debt amount.

Second, for creditors, the CARE System 10 is configured to collect/recover substantially more net dollars on 90+ delinquent unsecured consumer debts and deliver a significantly improved net present value on those dollars compared to current internal and external collections/recovery market solutions. While consumer debt collectors typically go after consumer deposit balances, future earnings, and other assets, the CARE System 10 harnesses and re-purposes totally different assets—consumer buying power and previously untapped, monetized non-dollar assets—to pay down creditor debt with an affordable and positive consumer solution. In this way, the CARE System 10 also helps creditors build a bridge back to distressed consumers for future credit extension as consumers regain their financial footings.

Third, from a retailer's perspective, the CARE System 10 redirects a new source of consumers with repeat monthly necessity spending levels to participating CARE retailers over an extended time period (on average, 3 years). In this regard, the CARE System 10 is configured to deliver billions of dollars in captive consumer spending to CARE participating retailers each year. In return for harnessing and delivering CARE consumers' captive buying power to CARE retailers (e.g., particularly those in the necessity spend category), these retailers provide the CARE System 10 with substantial spending rewards that are re-purposed to pay down consumers' debts to creditors (referred to as “earned rewards”).

The CARE System 10 sets up CARE Consumer Transaction Accounts for creditors' consumers to engage in a minimum spend amount (e.g., monthly necessity spending) with CARE retailers, which earns rewards at CARE retailers (i.e., the earned rewards). The earned rewards may then be combined with partial debt payments (e.g., small monthly payments relative to the payments that would be due to the creditor in a typical repayment scenario) to produce an enhanced payment amount to be provided to the creditor in an effort to satisfy the debt settlement amount. Distinctly different from other current internal and external collections market alternatives, which go after consumer deposit balances, future earnings, and other assets, the CARE System 10 also lowers the total debt consumers must repay (i.e., by establishing the debt settlement amount), substantially lowers monthly payments (i.e., by establishing the partial debt payment), stops collections and escalating fees, and provides ongoing incentives for staying on track (i.e., the earned rewards), effectively addressing the vicious cycle of the consumer debt trap.

The CARE System 10 also lets consumers invite their supporters (e.g., family/friends) into the program to harness and re-purpose their buying power at CARE retailers and other non-dollar assets to help accelerate creditor debt repayments or meet other financial needs. As consumers regain their financial footings, the CARE System 10 allows consumers and supporters (e.g., family/friends) to re-purpose their CARE accumulated assets that are in excess of creditor debt obligations and apply these excess assets to bill payments, savings, investments, charitable donations, and other financial needs and goals.

According to embodiments of the present invention shown in FIG. 1, the CARE System 10 comprises the following components/modules, which are described in detail below: a Creditor Collections Management Module 100; a Supporters Consumer Direct Acquisition Module 100A (according to an alternative embodiment); a Consumer Transaction Accounts Module 200; a Retailer Network & Reward Asset Collection Module 300; an Other Asset Collection & Monetization Module 400; an Asset Consolidator & Distributor Module 500; a CRM & Business Intelligence Analytics Engine 600; an Asset Distribution Director Module 700; a Consumer Management Module 800; a Derivative Products Module 900; and a Third Party Information & Tools Module 1000.

As shown, the above-identified primary components/modules may comprise one or more additional modules (e.g., modules 102, 104, 106, 108 of the Creditor Collections Management Module 100) configured to perform certain functions, operations, steps, and/or processes (collectively referred to as “operations”) which are performed, executed, and/or implemented by a “sub-module” identified in the Figures in the parenthetical associated with a module (e.g., sub-modules 102.1-102.3 associated with module 102). One having ordinary skill in the art will appreciate that distinct and separate sub-modules need not be utilized in order to carry out the described operations, but instead, any number of sub-modules may be integrated or combined to perform the described operations. The particular modules and sub-modules described herein are for illustration purposes only and are not intended to limit the scope of the embodiments of the present invention as requiring the specified arrangement of modules and/or sub-modules. One having ordinary skill in the art will appreciate that certain elements denoted with a “.X” identifier refer to a “status”, such as 108.1-108.7.

The modules and sub-modules of the CARE System 10 for the embodiments illustrated in FIGS. 1-8 are described in detail in the following sections, including a description of the functionality and processes performed by the respective modules and sub-modules. One having ordinary skill in the art will appreciate that the modules and sub-modules may be implemented by one or more computer devices and may include a combination of computer processing elements, computer storage, software code, etc. configured to perform the associated functionality. One having ordinary skill in the art will further appreciate that the modules and sub-modules described herein are for illustrative purposes and that two or more of the modules/sub-modules may be combined into a single module/sub-module and/or performed by any number of computing devices.

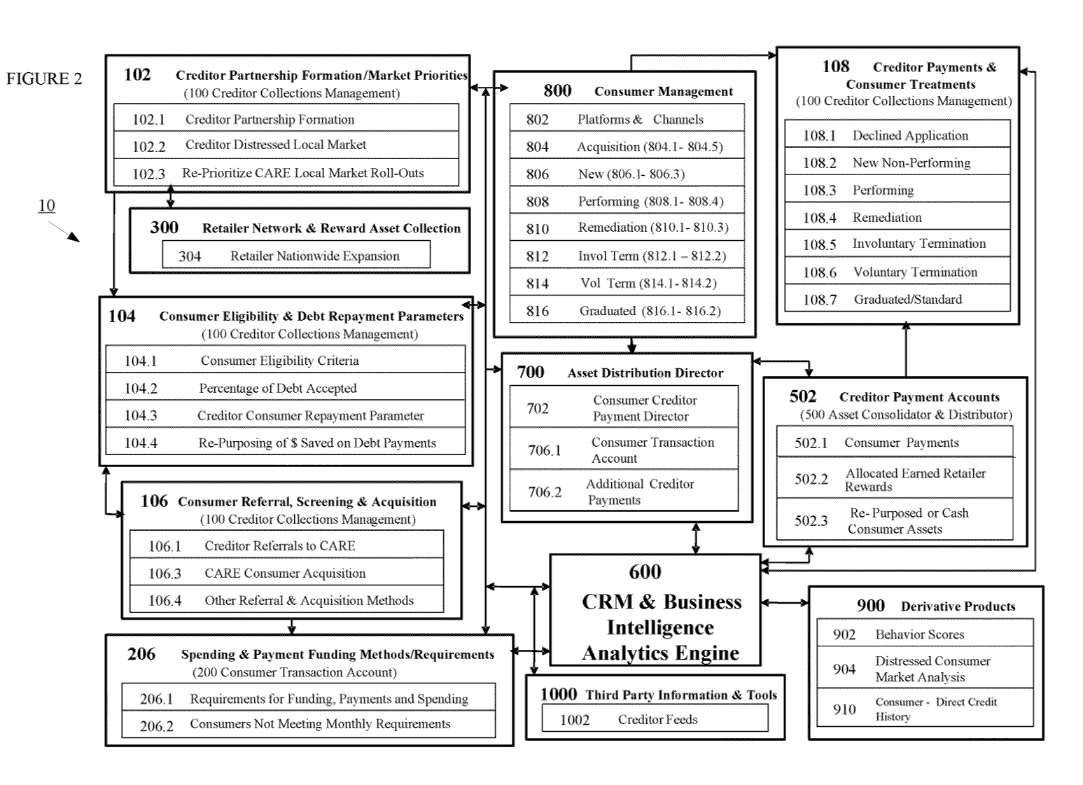

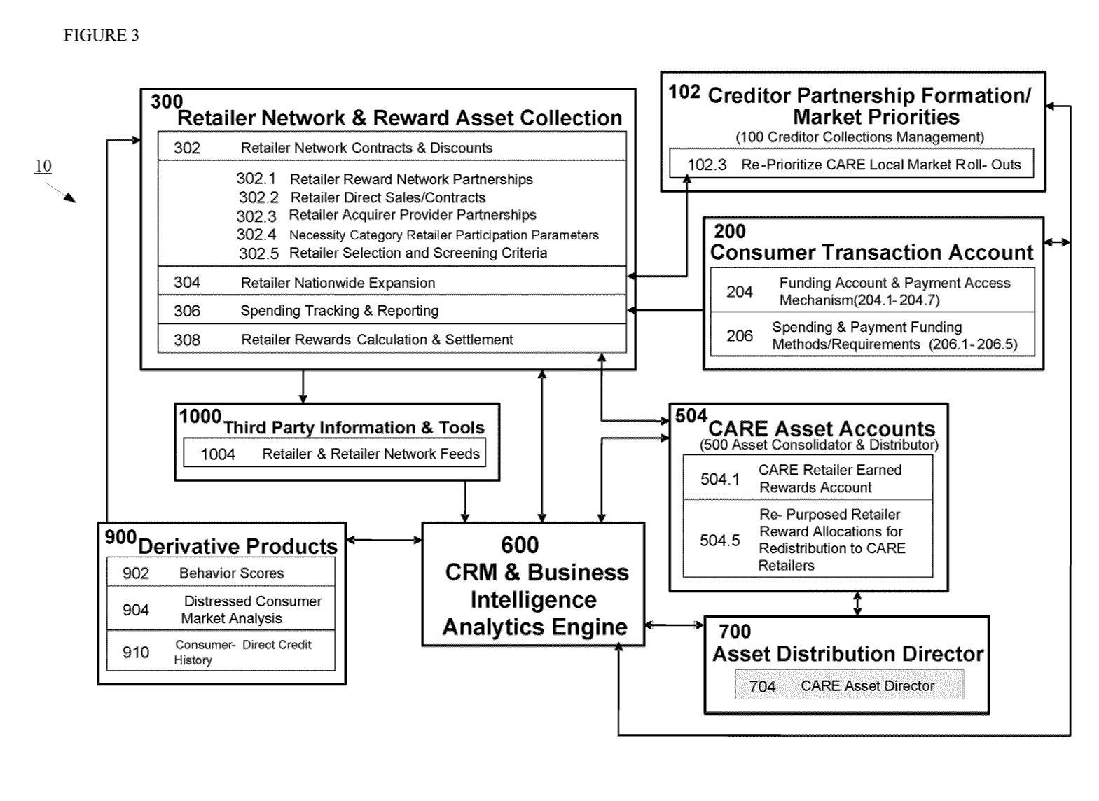

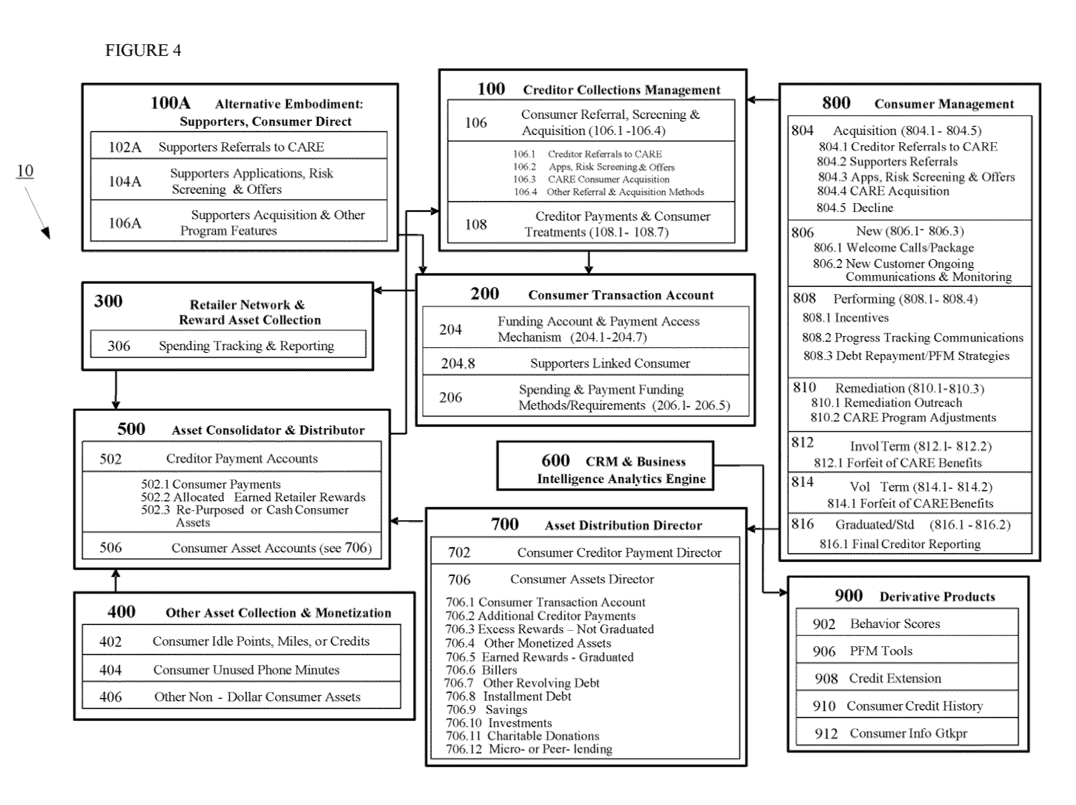

Alternative embodiments and various perspectives of the CARE System 10 are illustrated in FIGS. 2-4. Specifically, FIG. 2 presents an embodiment of the CARE System 10 from the creditor perspective, FIG. 3 presents an embodiment of the CARE System 10 from the retailer perspective, and FIG. 4 presents an embodiment of the CARE System 10 from the consumer perspective.

According to an embodiment of the present invention, the Creditor Collections Management Module 100 is configured to work with creditors to establish strategic partnerships to manage collections/recoveries on their 90+ delinquent unsecured loan consumers through the CARE program. According to embodiments of the present invention, the Creditor Collections Management Module 100 establishes creditor partnerships and distressed local market priorities, determines eligibility criteria and debt settlement/repayment parameters for creditors' consumers to enter the CARE program, refers and acquires creditors' consumers into the CARE program, and manages payment handling.

According to an embodiment of the present invention, the CARE System 10 may set up and maintain separate a Creditor Collections Management Module 100 for each creditor, or may use any number of Creditor Collections Management Modules 100 for the collection of creditors participating in the CARE program. Inputs to and/or outputs from the Consumer Transaction Account Module 200, the Asset Consolidator & Distributor Module 500, the CRM & Business Intelligence Analytics Engine 600, the Consumer Management Module 800, the Retailer Network Contracts & Discounts Terms Module 302 and the Retailer Nationwide Expansion Module 304 interact with and support the modules in the Creditor Collections Management Module 100. In addition, the Creditor Collections Management Module 100 sends creditor feeds to the Creditor Feed Module 1002.

According to an embodiment of the present invention, the Creditor Partnership Formation & Market Priorities Module 102 is configured establish strategic partnerships with creditors and acquire and manage collections/recoveries on the creditors' delinquent credit card consumers in each local geographic market through the CARE program. According to an embodiment of the present invention, the Creditor Partnership Formation & Market Priorities Module 102 may comprise the following sub-modules: a Creditor Partnership Formation sub-module 102.1 configured to work with creditors to establish strategic partnerships to acquire and manage collections/recoveries on their 90+ day delinquent credit card consumers in each local geographic market through the CARE program; a Creditor Distressed Local Market Priorities sub-module 102.2 configured to allow creditors to identify and prioritize distressed local markets with the highest concentration of their delinquent consumers causing loss and collections expense pain for CARE program utilization and rollout; and a Re-Prioritize CARE Local Market Rollouts sub-module 102.3 configured to allow the CARE System 10 to reprioritizes and add a local network (if it does not already have local CARE retailer network coverage in the creditor's high priority rollout markets) through the Retailer Network Contracts & Discounts Terms Module 302 and the Retailer Nationwide Expansion Module 304.

According to an embodiment of the present invention, the Consumer Eligibility & Debt Repayment Parameters Module 104 is configured to coordinate with creditors to determine CARE program eligibility criteria for the creditors' consumers, determine the debt settlement amount (i.e., an agreed-upon percentage of debt creditors accept as settlement-paid-in-full for consumers acquired into the CARE program), and the debt settlement repayment program parameters for their consumers in the CARE program. The Consumer Eligibility & Debt Repayment Parameters Module 104 also works with the Consumer Management Module 800 to set up the CARE platforms, channels, and processes for interacting with, supporting, and managing CARE consumers for all activity components in this module.

According to an embodiment of the present invention, the Consumer Eligibility & Debt Repayment Parameters Module 104 may comprise a Consumer Eligibility Criteria sub-module 104.1 configured to work with creditors to determine CARE program eligibility criteria for creditors' consumers. Consumer eligibility criteria elements include geography, stage of delinquency, enough income to support the reduced payments and minimum necessity spending for the size of the debt to be placed in the CARE program, credit/payment history prior to payment delinquency, bankruptcy status, and other demographic or behavior characteristics agreed upon with the creditor.

According to an embodiment of the present invention, the Consumer Eligibility & Debt Repayment Parameters Module 104 may comprise a Percentage of Debt Accepted Module 104.2 configured to determine the debt settlement amount or percentage of debt that creditors will accept as settlement-paid-in-full for consumers acquired into the CARE program, what impacts the debt settlements will have on their loss recognition processes, and how/when creditors will do consumer 1099 reporting for the loss portion of the debt settlements. The debt settlement amount, or percentage of the original debt, varies by creditor and considers the volume and stage of delinquency of eligible consumers the creditor expects to place in the CARE program. The debt settlement amount may also vary by the balance size segments the creditor expects to place in the CARE program, the degree of consumer pre-screening provided by the creditor, the creditor's own collections and recoveries performance, the creditor's strategic and customer goals for the program, and other factors. One having ordinary skill in the art will appreciate that in certain instances the debt settlement amount may be equal to the original debt amount (i.e., no reduction).

According to an embodiment of the present invention, the Consumer Eligibility & Debt Repayment Parameters Module 104 may comprise a Creditor Consumer Repayment Parameters sub-module 104.3 configured to communicatively connect to creditors to determine the debt settlement repayment program parameters for their consumers in the CARE program. Creditor consumer repayment term parameters may include, but is not limited to, a balance between expected adoption, attrition, consumer portfolio quality, and/or other success criteria tradeoffs to achieve the agreed-upon debt settlement amount and related return goals for consumers in the CARE program. Within the agreed upon parameters, consumers acquired into the CARE program repay the debt settlement through a mix of substantially reduced monthly payments and minimum monthly necessity purchase amounts at CARE retailers for a fixed number of months consistent with income and debt sizes.

According to an embodiment of the present invention, the Consumer Eligibility & Debt Repayment Parameters Module 104 may comprise a Re-Purposing of Dollars Saved On Monthly Debt Payments sub-module 104.4 configured to manage a consumer's re-purposing of dollars saved from their previous high monthly debt payments and track/record the saved amount in the Consumer Transaction Account Module 200 to supplement household necessity shopping budgets, help meet monthly spending commitments to CARE retailers (as described in detail below with respect to the Retailer Network & Reward Asset Collection Module 300), and other needs.

According to an embodiment of the present invention, the Consumer Referral, Screening & Acquisition Module 106 is configured to refer creditors' eligible consumers to the CARE program; perform risk screens and extend offers to the consumers; and registers the consumers into the CARE program for collections and recovery management. The Consumer Referral, Screening & Acquisition Module 106 is also communicatively connected to the Consumer Management Module 800 and configured to set up the CARE platforms, channels, and processes for interacting with, supporting, and managing CARE consumers for all activities components in this module.

According to an embodiment of the present invention, the Consumer Referral, Screening & Acquisition Module 106 comprises a Creditor Referrals to CARE sub-module 106.1 configured to refer, enroll, register or illicit creditors' eligible consumers into the CARE program. According to an embodiment of the present invention, the preferred referral method is a “warm” transfer of pre-screened eligible 90+ day delinquent consumer prospects from the creditor's collections call center to the CARE call center.

According to an embodiment of the present invention, the Consumer Referral, Screening & Acquisition Module 106 comprises a Consumer Applications, Risk Screening & Offers sub-module 106.2 configured to allow CARE representatives to describe the CARE program, take applications, and process applications through the CRM & Business Intelligence Analytics Engine 600 for risk screening, approval/denials, and offer terms. Offer terms may include, but are not limited to, a debt settlement amount paid off over X months through a combination of partial debt payments made by the consumer (e.g., a reduced fixed monthly payment submitted by the consumer via the CARE System 10) and a minimum spend amount at a list of designated CARE retailers set up by the Retailer Network Contracts & Discounts Module 302.

The term “partial debt payment” is intended to include any payment made by a consumer to be applied toward the debt settlement amount. The partial debt payment may be an amount fixed by the CARE System 10, and may be paid on a periodic basis (e.g., monthly). The term “minimum spend amount” is intended to include an amount spent by the consumer with one or more of the designated CARE retailers. According to an embodiment of the present invention, the minimum spend amount may comprise spending on goods and/or services which are deemed to be “necessary” for the maintenance of the consumer's lifestyle (also referred to as necessity shopping or necessity spending). For example, the necessity shopping or spending may comprise spending relating to utilities, clothing, food, etc.

According to an embodiment of the present invention, circumstances within an individual consumer's life cycle may be taken into consideration in establishing a mix or blend of the minimum spend amount (e.g., necessity spending and payments) contained in the original arrangement with the consumer (CARE representatives make offers to and/or arrangements with the creditors' consumers). The Retailer Network & Reward Asset Collection Module 300, the Other Asset Collection & Monetization Module 400, and the Consumer Management Module 800 address the CARE program consumer performance and other asset collection circumstances that can shift consumers' required payment/spending mixes while they are involved in the CARE program.

According to an embodiment of the present invention, the Consumer Referral, Screening & Acquisition Module 106 comprises a CARE Consumer Acquisition sub-module 106.3 configured to allow the CARE System 10 to input, store, record, and manage consumers' agreements For acquisition into the CARE program. Once consumers are acquired and registered in the CARE program, creditors typically halt their own collections efforts and additional fees on the consumers' delinquent or charged off debt balances and accept the previously agreed upon debt settlement amount as payment in full, subject to successful CARE program completion.

According to an embodiment of the present invention, the Consumer Referral, Screening & Acquisition Module 106 comprises an Other Referral & Acquisition sub-module 106.4 configured to provides other methods of reaching the creditor's eligible consumers for acquisition into the CARE program, including, but not limited to, CARE and/or creditor direct-mail, web-based communications, mobile messaging, telemarketing, social networking, advertising, and public relations channels. The CARE System 10 risk-screens, approves, makes offers to, and acquires creditors' consumers entering through these channels in the same general manner described above, with consumer interaction process customization that best fits the acquisition entry channel.

According to an embodiment of the present invention, the Creditor Payments & Consumer Treatments Module 108 is configured to receive/process creditors' payments to pay down CARE program consumers' debt settlement amount pursuant to the applicable agreement and provide for creditors' treatment of consumers based on their performance statuses in the CARE program. According to an embodiment of the present invention, creditors receive and process regular monthly debt payments for their consumers in the CARE program for collections/recovery management received from the Creditor Payment Account Module 502, In addition, creditors receive regular performance status reporting on their consumers in the CARE program from the Consumer Management Module 800 that determines the following creditor treatments or impacts:

Declined Application status 108.1: Consumers in the Decline sub-module 804.5 have applied and been declined acceptance into the CARE program for collections/recovery management. Creditors place these consumers back into their own collections/recovery process for the full amount of the original debt.

New Non-Performing status 108.2: Consumers in the New Module 806 do not make their first payment or do not start spending in the first month are transferred back to creditors to place these consumers back into their own collections/recovery process for the full amount of the original debt.

Performing status 108.3: Consumers in the Performing Module 808 are current on monthly payments to the CARE System 10 and/or minimum spend amount at CARE retailers. Creditors regularly receive and post CARE payments from the Creditor Payment Account Module 502 to pay down the consumers' agreed-upon debt settlement amount, including any re-purposed accumulated other assets or additional payments consumers have directed to the module through the Consumer Assets Director 706 to accelerate repayment of their agreed-upon debt settlements to creditors. Creditors may also regularly report the CARE payments made on behalf of CARE consumers' to the credit bureaus.

Remediation status 108.4: Consumers in the Remediation Module 810 have fallen behind on monthly payments to the CARE System 10 and/or are not spending at least the minimum spend amount, and are being given remediation opportunities. Creditors may receive no or a portion of the partial debt payments to process from the Creditor Payment Account 502 while consumers are in this status. If/when consumers are returned to the Performing Module 808, creditors may receive catch-up CARE payment amounts immediately or later if the consumer's repayment program was extended to make it more manageable for the consumer. According to an embodiment of the present invention, creditors may also report the missed or fractional partial debt payments to the credit bureaus.

Involuntary Termination status 108.5: Consumers in the Involuntary Termination Module 812 are terminated from the CARE program and the CARE System 10, their debt settlements are forfeited, and they are transferred back to the creditor for continued non-performance in the CARE program after a period of remediation opportunities through the Remediation Module 810. Optionally, creditors may place these consumers back into their own collections/recovery process for the full amount of the original debt minus any payments made via the CARE System 10 to-date. Creditors may also report the CARE program terminations and debt settlement cancellations to the credit bureaus, and resume ongoing negative credit bureau reporting.

Voluntary Termination status 108.6: Consumers in the Voluntary Termination Module 814 have been current on CARE program commitments, but voluntarily terminate/withdraw from the CARE program without completing their agreed-upon debt settlement repayment obligations to the creditor. Their debt settlements are forfeited and they are transferred back to the creditor for non-petformance in the CARE program. Creditors place these consumers back into their own collections/recovery process for the full amount of the original debt minus any CARE payments to-date. Creditors may also report the CARE program terminations and debt settlement cancellations to the credit bureaus, and resume ongoing negative credit bureau reporting.

Graduated/Standard status 108.7: Consumers in the Graduated/Standard Module 816 have graduated from, or successfully completed, the CARE program for collections/recovery management by fully repaying their debt settlement repayment obligations to the creditor (i.e., the debt settlement amount). Creditors may report CARE program debt settlement repayment as settled-paid-in-full or debt paid-in full to the credit bureaus. Creditors may also opt to re-extend credit or other products to these consumers.

According to an embodiment of the present invention, the CARE System 10 may comprise a Supporters Consumer Direct Acquisition Module 100A configured to process and/or receive supporters' invitations and referrals from consumers in the CARE program; risk screens and makes offers to the supporters; and acquires, registers, enrolls, them into the CARE program and the CARE System 10. The Supporters Consumer Direct Acquisition Module 100A (and associated modules 102A-106A) receive inputs to and send outputs about their activities to the CRM & Business Intelligence Analytics Engine 600.

According to embodiments of the present invention, the Supporters Consumer Direct Acquisition Module 100A comprises one or more of the following sub-modules:

A Supporter Referrals to CARE Module 102A configured to provide consumers in the CARE program for collections/recovery management a platform and vehicle to invite/persuade supporters to join in helping the consumers recover from their debt traps. According to embodiments of the present invention, methods of referrals and applications may include, but are not limited to, warm transfers of CARE program consumer calls to supporters within the CARE call center, applications provided to supporters by CARE program consumers to this module by direct mail, and/or web-based online applications through this module.

A Supporter Applications, Risk Screening & Offers Module 104A configured to provide and store information to allow CARE System 10 call center representatives, the applications, or the online web-site to describe the CARE program for the supporters. Supporters agree to establish CARE Consumer Transaction Accounts, shop at CARE retailers, and re-purpose all or a portion of their rewards earned for shopping with the CARE retailers (herein referred to as “supporter-earned rewards”) and/or other assets collected, monetized, and re-purposed to designated consumers in the CARE program to accelerate the designated consumers'debt settlement repayment plans. The Supporter Applications, Risk Screening & Offers Module 104A then takes and processes the applications through the CRM & Business intelligence Analytics Engine 600 for risk screening, approvals, and offers. An offer may include a list of CARE retailers from the Retailer Network Contracts & Discounts Module 302 where supporters' spending will earn rewards (i.e., supporter-earned rewards). Supporters also designate the consumer or consumers in the CARE program for collections/recovery program to whom they want to re-purpose their supporter-earned rewards or other assets, how much of their spending will be designated, and for how long. The Other Asset Collection & Monetization Module 400 addresses other assets supporters can also accumulate and optionally re-purpose to consumers in the CARE program.

A Supporter Acquisition & Other Program Features Module 106A configured to allow CARE System 10 representatives to input, identify and manage supporter agreements for acquisition into the CARE program. Earned shopping rewards and other assets that supporters do not re-purpose to designated CARE program consumers accrue in their own personal Consumer Asset Account 506 until supporters issue distribution instructions through the Asset Distribution Director Module 700. While in the CARE program, supporters may alter their donation instructions or stop using their CARE consumer transaction accounts, and receive regular reports from the Consumer Management Module 800 about their designated consumers' CARE program completion progress. Optionally, they may also help CARE program consumers in regaining some lost financial ground with additional asset re-purposing to their designated consumers' Consumer Asset Accounts 506 for bill payments, safety net savings, or other needs so that their designated consumers do not repeat the debt cycle.

According to an embodiment of the present invention, the Consumer Transaction Account Module 200 receives CARE consumers and supporters acquired through the Consumer Referral, Screening & Acquisition Module 106 and Supporter Consumer Direct Acquisition Modules 100A. The Consumer Transaction Account Module 200 is communicatively connected to card program providers and/or banks and establishes a partnership to issue CARE Consumer Transaction Accounts and provide customer support and processing/settlement services and/or works directly with consumers to register their own Consumer Transaction Accounts for use in the CARE program. The Consumer Transaction Account Module 200 sets up CARE program funding accounts and payment access mechanisms (collectively, the Consumer Transaction Account) for consumers acquired into the CARE program. The Consumer Transaction Account Module 200 also provides funding methods/options and requirements for periodic (e.g., monthly) minimum spend amounts (e.g., necessity spending) at CARE retailers and periodic (e.g., monthly) partial debt payments (i.e., CARE payments). In addition, the Consumer Transaction Account Module 200 sets up recurring ACH debit authorizations for consumers' monthly payments to the Creditor Payment Account Module 502.

In addition, the Consumer Transaction Account Module 200 receives and adds funds to Consumer Transaction Accounts based on consumer instructions to the Consumer Transaction Account sub-module 706.1 to re-purpose and distribute unrestricted accumulated other assets from the Consumer Asset Accounts Module 506. The module also sends consumers not maintaining sufficient balances in their funding account to meet CARE program commitments, to the Remediation Module 810 for further action.

According to an embodiment of the present invention, all modules and sub-modules within the Consumer Transaction Account Module 200 receive business strategies outputs from and reports their activities and information to the CRM & Business Intelligence Analytics Engine Module 600.

According to embodiments of the present invention, the Consumer Transaction Account Module 200 comprises a Provider Partnership Formation Module 202 communicatively connected to card/other payment access mechanism program providers and banks and configured to establish strategic partnerships to set up/issue and support the direct CARE Consumer Transaction Account options described in the Funding Account & Payment Access Mechanism Set-Up Module 204 and Spending & Payment Funding Methods/Requirements Module 206. The Provider Partnership Formation Module 202 may have associated therewith certain strategic partners that provide product and product feature support, customer service support, risk and compliance support, and transaction processing, authorization, and settlement services.

According to embodiments of the present invention, the Consumer Transaction Account Module 200 comprises a Funding Account & Payment Access Mechanism Set-Up Module 204 configured to select and issue or register CARE program consumer and supporters funding accounts and payment access mechanisms (collectively, the “Consumer Transaction Account”) used to fund monthly payments to the Creditor Payment Account Module 502 and to fund and conduct monthly necessity spending at CARE retailers. According to an embodiment of the present invention, the Funding Account & Payment Access Mechanism Set-Up Module 204 selects and issues or registers at least one of the following Consumer Transactions Accounts for CARE consumers:

CARE Prepaid 204.1: A CARE-issued association-branded general purpose prepaid card;

CARE ACH Debit 204.2: A CARE-issued association-branded general purpose ACH debit card linked to the consumer's own deposit account;

Registered Debit 204.3: Registration of the consumer's own association-branded general purpose debit card and linked deposit account; or

Registered Other Access Deposit Mechanism 204.4: Registration of the consumer's own other access mechanism, e.g. mobile phone, and linked deposit account.

In addition, supporters (e.g., family/friends) and other credit-qualifying CARE program consumers may be given the option of setting up or an upgrade to one of the following account types:

CARE Credit 204.5: A CARE-issued association-branded general purpose credit card or a CARE-issued association-branded general purpose prepaid card or ACH debit card linked to both a deposit account and a credit line;

Registered Credit 204.6: Registration of the consumer's own association-branded general purpose credit card; or

Registered Other Credit Access Mechanism 204.7: Registration of the consumer's own alternate access mechanism, e.g. mobile phone, and linked credit account.

The Funding Account & Payment Access Mechanism Set-Up Module 204 may also comprise a Supporter Linked Consumer Module 204.8 configured to enable supporters to designate and set up which consumers in the CARE program for collections/recovery management are to receive re-purposed earned spending rewards or other assets, how much spending and/or other assets to re-purpose, and for how long. Supporters may later alter these instructions through the Consumer Assets Directors Module 706.

According to embodiments of the present invention, the Consumer Transaction Account Module 200 comprises a Spending & Payment Funding Methods/Requirements Module 206 configured to provide the funding methods for Consumer Transaction Accounts, and interactions with the requirements for CARE program consumers and their supporters to support spending to reach the minimum spend amounts monthly at CARE retailers, and payments to creditors.

According to embodiments of the present invention, the Spending & Payment Funding Methods/Requirements Module 206 comprises a Requirements for Funding, Payments & Spending sub-module 206.1 configured to require consumers in the CARE program for collections/recovery management to fund and conduct minimum monthly necessity spending amounts at CARE retailers The consumers may also fund, authorize, and set up recurring ACH debits from the Consumer Transaction Account for agreed-upon monthly payments to the Creditor Payment Account Module 502. These consumers may fund, make payments, and make spending to satisfy the minimum spend amount for a period of time agreed upon when the consumer entered the program. The consumer may re-purpose their funds saved from lowering their monthly debt payment to help fund their CARE Consumer Transaction Accounts.

According to an embodiment of the present invention, Supporters have no minimum monthly necessity spending and no monthly payment requirements. Consumers and supporters may also add funds to their funding account from any unrestricted assets they have accumulated in the Consumer Asset Accounts Module 506 by sending instructions to the Consumer Assets Directors Module 706.

According to embodiments of the present invention, the Spending & Payment Funding Methods/Requirements Module 206 comprises a Consumers Not Meeting Monthly Requirements sub-module 206.2 configured to send consumers not maintaining sufficient balances or deposits in their Consumer Transaction Account to meet required CARE program for collections/recovery management commitments and their supporters to the Remediation Module 810 for further action.

According to embodiments of the present invention, the Spending & Payment Funding Methods/Requirements Module 206 comprises a Prepaid Card Methods sub-module 206.3 configured to provide the prepaid card methods for CARE program monthly funding, payments, and spending. If the Consumer Transaction Account is a CARE prepaid card, consumers load enough cash deposits to the prepaid card to cover monthly necessity spending at CARE retailers and agreed-upon CARE ACH recurring debits for monthly payments, if applicable. Consumers may make deposits once a month or more or less frequently as long as the deposited funds are enough to cover required or optional necessity spending and payments.

The preferred prepaid card deposit method for consumers with a deposit account or regular source of income account such as payroll, retirement, or government benefits is a consumer-authorized regular automatic ACH deposit to the prepaid card. The Prepaid Card Methods sub-module 206.3 provides CARE prepaid card consumers without such an account or who do not authorize automatic ACH deposits with two options for making cash deposits to the CARE prepaid card. First, the consumers may regularly authorize and load one-time cash deposits to the prepaid card from a deposit account funding source account not registered with the CARE program through a web connection of the Prepaid Card Methods sub-module 206.3 or telephone transfer facility. Second, the consumers may make regular cash deposits at prepaid card cash load/reload network locations such as, for example, Western Union, Money Gram, or Green Dot, provided through the Prepaid Card Methods sub-module's 206.3 service partners.

According to embodiments of the present invention, the Spending & Payment Funding Methods/Requirements Module 206 comprises a Payment Access Mechanisms Linked to Deposit Accounts Methods sub-module 206.4 configured to provide the payment account mechanisms linked to deposit accounts methods for CARE program monthly funding, payments, and spending. If the Consumer Transaction Account is a payment access mechanism linked to a deposit account, the consumer accesses the deposited balances through the payment access mechanism's linked deposit account to cover required or optional monthly necessity spending at CARE retailers and CARE ACH recurring debits for monthly payments. According to an embodiment of the present invention, consumers must maintain sufficient balances in the linked deposit account to authorize required or optional monthly necessity shopping and CARE monthly payments, if required.

According to embodiments of the present invention, the Spending & Payment Funding Methods/Requirements Module 206 comprises a Payment Access Mechanisms Linked to Credit Accounts Methods sub-module 206.5 configured to provides the payment account mechanisms linked to credit accounts methods for CARE program to fund optional monthly spending and payments. For consumers who are credit-qualified, if the Consumer Transaction Account is a payment access mechanism linked to a credit account, the consumer accesses the available credit line to cover optional monthly necessity spending at CARE retailers and CARE payments. Consumers must have sufficient available credit to authorize desired monthly necessity shopping and CARE monthly payments.

According to an embodiment of the present invention, the Retailer Network & Reward Asset Collection Module 300 is configured to secure contracts with necessity category retailers to participate in the CARE retailer network on a local market basis and provide rewards for CARE program consumer and supporters shopping, and expands local CARE retailer networks to a nation-wide network of local CARE retailer networks. It also earns rewards for CARE program consumer and supporters monthly necessity spending at CARE network retailers, and calculates, collects, and transmits CARE retailer rewards to the 504 CARE Asset Accounts module. In addition, all components in this module receive business strategies, information, and policy outputs from and report their activities and information to the CRM & Business Intelligence Analytics Engine 600.

According to an embodiment of the present invention, the Retailer Network & Reward Asset Collection Module 300 comprises a Retailer Network Contracts & Discounts Module 302 configured to select and secure contracts with appropriate necessity category retailers in each local market to create and participate in local CARE retailer networks for CARE consumer necessity shopping. It also selects and secures contracts with appropriate necessity category online retailers for CARE consumer necessity shopping which may or may not also be participating in local market networks. The Retailer Nationwide Expansion Module 304 sets the local market roll-out priorities for this module. According to embodiments of the present invention, the Retailer Network Contracts & Discounts Module 302 may use several methods to source, select, and secure contracts with retailers, including, but not limited to the following:

Retailer Reward Network Partnerships 302.1: wherein the Retailer Nationwide Expansion Module 304 forms partnerships with and through retailer reward networks for selecting and contracting with retailers;

Retailer Direct Sales/Contracts 302.2: wherein the Retailer Nationwide Expansion Module 304 utilizes direct sales to and contracts with retailers; and/or

Retailer Acquirer Provider Partnerships 302.3: wherein the Retailer Nationwide Expansion Module 304 forms partnerships with and works with retailer acquirer providers such as banks or other retailer acquirers to gain access to retailers for direct sales and contracts with retailers and/or outsources sales and contracts to the retailer acquirer providers.

According to an embodiment of the present invention, the Retailer Nationwide Expansion Module 304 comprises a Necessity Category Retailer Participation Parameters sub-module 302.4 configured to provide the CARE retailer network participation parameters. CARE retailers that are deemed to be “necessity category retailers” include, but are not limited to grocery stores, gas retailers, clothing stores, everyday household item retailers, drug stores, discount department stores, and other types of retailers that sell household necessity items. The Necessity Category Retailer Participation Parameters sub-module 302.4 provides each necessity category retailer selected and agreeing to participate in the local CARE retailer network with exclusive access to CARE consumer necessity shopping for that necessity retailer category, e.g., gas retailers Chevron and Arco cannot participate in the same local retailer network. For driving captive local CARE consumer shopping dollars in that category to the retailer, the retailer agrees in the contract to provide an attractive specific percentage discount reward for total CARE consumer spending using the CARE payment access mechanism at all of their locations in the local network.

In addition, if the retailer has an online e-commerce web presence, the retailer agrees in the contract to provide the same specific percentage discount reward for total CARE consumer spending using the CARE payment access mechanism on the e-commerce site. Online necessity category retailers may participate whether or not they also participate in a local CARE retailer network under the same terms.

According to an embodiment of the present invention, the Retailer Nationwide Expansion Module 304 comprises a Retailer Selection and Screening Criteria sub-module 302.5 configured to establish and provide selection and screening criteria for each necessity category retailer for a local market and/or online. The criteria includes exemplary factors such as the number and convenience of retail locations relative to participating CARE program consumers, the size of the discount reward percentage the retailer is offering, the mix and volume of necessity items carried, and local or national reputation.

According to an embodiment of the present invention, Retailer Nationwide Expansion Module 304 is configured to prioritize and schedule the ramp up of local CARE retailer networks in the Retailer Network Contracts & Discounts Module 302 until the CARE retailer network reaches nationwide coverage. The Retailer Nationwide Expansion Module 304 interacts with and gives rollout priority to creditor partners' distressed local markets with the highest concentration of their delinquent consumers identified in the Creditor Partnership Formation & Market Priorities Module 102.

According to an embodiment of the present invention, the Spending Tracking & Reporting Module 306 configured to tracks necessity and other spending on CARE payment access mechanisms at CARE retailers by consumers in the CARE program and reports it to the Retailer Rewards Calculation & Settlement Module 308. The Retailer Rewards Calculation & Settlement Module 308 is configured to receive, aggregate, and analyze necessity and other spending reporting from the Spending Tracking & Reporting Module 306, calculates CARE retailer earned rewards on CARE program consumer and supporters' spending, and settles the earned reward dollars from/to retailers and CARE. It transmits the dollars and associated earned rewards amount information for each CARE program consumer at each CARE retailer to the CARE Asset Accounts Module 502, and receives a share of earned rewards back for involuntarily or voluntarily terminated CARE consumers from the CARE Asset Accounts Module 502 for distribution back to the originating retailer. In addition, the module sends CARE consumer spending behavior and earned rewards reporting to the CRM & Business Intelligence Analytics Engine 600.

According to an embodiment of the present invention, the Other Asset Collection & Monetization Module 400 is configured to manage, track and store information relating to negotiations with CARE program consumers and supporters' other loyalty reward program or service providers (e.g., banks, retailers, airlines, phone companies, credit cards, and other organizations) to monetize and settle CARE consumers' idle/unused non-dollar assets such as points, miles, credits, phone minutes, or other assets for cash values. While the cash values are likely to settle at lower rates than if the consumers redeemed their loyalty rewards directly through the companies' program, this module allows CARE program consumers to leverage and make available a pool of additional otherwise idle/unused assets they may not have considered or had access to pay down debt and/or meet other needs. For supporters, this option provides an additional way to assist their designated CARE program consumers to get out of their debt traps.

Other Asset Collection & Monetization Module 400 then monetizes and transmits the cash values to the CARE program consumers' Consumer Asset Accounts Module 506 to re-purpose for other needs. Consumers in the CARE program for collections/recovery management may re-purpose these assets to accelerate their debt repayment plans or to meet other needs such as bill payments or savings. Supporters may re-purpose some or all of these assets to their designated consumers in the CARE program to accelerate their debt settlement repayments or meet other needs, or retain them in their own asset accounts to re-purpose for their own needs, such as bill payments, savings, charitable donations, and like.

In addition, all components within this module receive business strategies, information, and policy outputs from and report their activities and information to the CRM & Business intelligence Analytics Engine 600.

According to an embodiment of the present invention, the Consumer Idle Points, Miles, or Credits Module 402 is configured to manage the consumers and supporters unused, idle rewards points, miles, or credits sitting idle in other companies' loyalty reward programs, e.g. airline miles generated by frequent flyer programs or card program rewards points. The Consumer Idle Points, Miles, or Credits Module 402 manages, tracks, and stores information relating to negotiations with the companies providing the loyalty rewards program and agrees upon cash settlement values for the unused/idle rewards, monetizes and settles the cash values from the companies to CARE, and transmits those cash values to CARE program consumers' Consumer Asset Accounts Module 506 for re-purposing to meet other needs.

According to an embodiment of the present invention, the Consumer Unused Phone Minutes Module 404 is configured to manage the consumers and supporters unused phone plan minutes with their phone service providers. The Consumer Unused Phone Minutes Module 404 manages, tracks, and stores information relating to negotiations with the phone service providers and establishes agreement upon cash settlement values for the unused phone plan minutes, monetizes and settles the cash values from the phone service providers to CARE, and transmits the cash values to CARE program consumers' Consumer Asset Accounts 506 for re-purposing to meet other needs.

According to an embodiment of the present invention, the Other Non-Dollar Consumer Assets Module 406 is configured to manage other non-dollar assets earned by the consumers and supporters, such as, for example, barter and/or other earned “credits” at times in the broader market place. The Other Non-Dollar Consumer Assets Module 406 manages, tracks, and stores information relating to negotiations with the providers of these non-traditional assets and agrees upon cash settlement values for these assets, monetizes and settles the cash values from the providers to CARE, and transmits the cash values to CARE program consumers' Consumer Asset Accounts 506 for re-purposing to meet other needs.

According to an embodiment of the present invention, the CARE System 10 comprises an Asset Consolidator & Distributor Module 500 configured to receive, hold, re-purpose, and distribute assets for each creditor in the Creditor Payment Accounts, earned retailer reward assets in the CARE Asset Accounts, and allocated excess earned retailer rewards assets and other monetized consumer assets for each CARE program consumer in the Consumer Asset. Accounts. The Asset Consolidator & Distributor Module 500 receives dollars transmitted from the Spending & Payment Funding Methods/Requirements Module 204, Retailer Rewards Calculation & Settlement Module 308, and Other Asset Collection & Monetization Module 400. The Asset Consolidator & Distributor Module 500 may store or hold the assets until the Asset Distribution Director Module 700 instructs the Asset Consolidator & Distributor Module 500 where, when, and how to re-purpose and distribute the assets, and reports the execution of its re-purposing and distribution activities back to that module. In addition, all components within this module receive business strategies and information outputs from and report their activities and information to the CRM & Business Intelligence Analytics Engine 600.

According to an embodiment of the present invention, the Creditor Payment Accounts Module 502 is configured to receive, hold, re-purpose, aggregate, and distribute one or more of the following:

Required Consumer Payments 502.1: Each creditor's CARE program consumers' authorized recurring ACH credits from the Spending & Payment Funding Methods/Requirements Module 204;

Allocated Earned Retailer Rewards 502.2: Each creditor's share allocation of earned CARE retailer spending rewards from the CARE Asset Accounts 504 for each of the creditor's CARE program consumers and supporters; and/or other third parties.

Re-Purposed or Cash Consumer Assets 502.3: Creditor CARE program consumers' assets from their Consumer Asset Accounts 506 that consumers and supporters have re-purposed or added as cash payments to make additional creditor payments through instructions to the to the Additional Creditor Payments Account sub-module 706.1.

The Creditor Payment Accounts Module 502 maintains these sub-accounts for each creditor along with payment and share allocations of earned CARE retailer rewards information for each of the creditor's consumers and supporters in the CARE program. At regular intervals, usually monthly, the Consumer Creditor Payment Director Module 702 instructs Creditor Payment Accounts Module 502 to re-purpose, aggregate, and distribute payments to each creditor's Creditor Payments & Consumer Treatments Modules 108. The payment transmittal includes payments, earned CARE retailer rewards, and other consumer asset additional payment details for each of the creditor's consumers and supporters in the CARE program.

According to an embodiment of the present invention, the CARE Asset Accounts Module 504 is configured to receive, re-purpose, hold, and allocate/distribute earned retailer rewards dollars from the Retailer Rewards Calculation & Settlement Module 308 based on instructions from the CARE Asset Director Module 704. The CARE Asset Accounts Module 504 may also maintain sub-accounts for each of the following account types:

CARE Retailer Earned Rewards Account 504.1: Receives and holds all CARE retailer earned rewards and associated earned rewards amount information for each CARE program consumer and family/friend at each retailer from the Retailer Rewards Calculation & Settlement Module 308 until these rewards are allocated to other sub-accounts in this module. Assets not re-purposed to other sub-accounts in this module remain in this account for CARE use;

Retailer Minimum Re-Purposed Earned Rewards Allocations for Creditors' Consumers 504.2: Receives and holds creditors' CARE consumer and their supporters re-purposed minimum monthly earned rewards allocations for distributions at regular intervals to the Creditor Payment Accounts Module 502;

Retailer Re-Purposed Excess Earned Rewards Allocations for Creditors' Consumers Not Yet Graduated 504.3: Receives and holds creditors' not-yet graduated CARE consumers and their supporters re-purposed monthly earned rewards allocations for exceeding required monthly spending minimums for distributions at periodic intervals to the Consumer Asset Accounts Module 506;

Re-Purposed Retailer Rewards Allocations for Creditors' Graduated Consumers and Their Supporters 504.4: Receives and holds creditors' graduated CARE consumer and supporters re-purposed monthly earned rewards allocations for monthly spending for distributions at periodic intervals to the Consumer Asset Accounts Module 506; and/or

Re-Purposed Retailer Reward Allocations for Redistribution to CARE Retailers 504.5: Receives and holds CARE retailers' share of creditors' voluntarily or involuntarily terminated CARE consumer and supporters forfeited earned rewards allocations for monthly spending. Forfeited rewards shares for retailers are re-purposed and distributed at periodic intervals to the Retailer Rewards Calculation & Settlement Module 308 for re-distribution back to the originating CARE retailers.

According to an embodiment of the present invention, the Consumer Asset Accounts Module 506 is configured to receive, hold, allocate, and distribute re-purposed earned retailer rewards dollars and other consumer and supporters assets from the CARE Asset Accounts Module 504 and Other Asset Collection & Monetization Module 400 based on asset allocations and detailed payment destination instructions from the Consumer Assets Director Module 706. The Consumer Asset Accounts Module 506 also sets up asset accounts for, maintains, and holds any consumer and supporters asset sub-accounts, additional payments, and payment destination distribution details as directed by the Consumer Assets Director Module 706. If consumers or supporters have not yet set up and/or designated instructions for any sub-account options, consumers' assets are maintained and held in the consumer's or supporter's general receiving and holding consumer asset account in this module until sub-account allocation and/or distribution instructions are received.

According to an embodiment of the present invention, the CARE System 10 comprises a CRM & Business Intelligence Analytics Engine 600 configured to set up and manage the infrastructure to receive, organize, store, segment, blend, and analyze CARE consumer, strategic partner, product, marketing, risk, application, transaction behavior and performance, and strategy information from and provide business strategy, process, and product outputs to all of the other CARE modules, CRM & Business Intelligence Analytics Engine 600 may also conduct performance analysis, modeling, and scoring; develops strategies and product design components; designs and implements tests for products and strategies; and measures/reports on performance and results for all parts of CARE. CRM & Business Intelligence Analytics Engine 600 may work with third party CRM, technology, predictive modeling tools and services, software, risk, and other providers to establish partnerships and contracts that assist in setting up, building, providing, and/or managing the infrastructure in this module.

According to an embodiment of the present invention, the CRM & Business Intelligence Analytics Engine 600 processes and stores the information, business intelligence, analytics, strategy, policy, and products engine for the CARE System 10. It cross-links, segments, integrates, unifies, and analyzes CARE modules' information and activities and transforms them into a powerful ecosystem of strategies, products, scoring and strategy management tools, and continuous, sophisticated information and feedback loops that power the CARE invention and its modules. The CRM & Business Intelligence Analytics Engine 600 captures, tracks, analyzes, learns from and adapts to, and measures CARE module results. Furthermore, the CRM & Business Intelligence Analytics Engine 600 may conduct and support many small tests and combinations of consumer, product, risk, marketing, and partner strategies and segments to maximize learning and minimize risks and costs. This allows quick ramp of successful strategies and quick exits or course corrections when they are not working.

Advantageously, the CRM & Business Intelligence Analytics Engine 600 may be used to deepen CARE's relationships and flexibility with CARE consumers and partners by enabling exceptionally high degrees of customization and integration down to the individual CARE consumer and partner level. Furthermore, the CRM & Business Intelligence Analytics Engine 600 also leverages information sharing arrangements with partners—creditors, retailer networks, retailers, banking product providers, technology, operational—as well as other third party information or service providers to increase the robustness of the module's engine. In addition, its strategy outputs and insights help CARE modules set goals/objectives; dedicate resources and dollars; decide what new products to offer, when, and how they will be managed; and facilitate CARE upgrades, implementation, and growth.

According to embodiments of the present invention, the CARE System 10 comprises an Asset Distribution Director Module 700 configured to set up business platforms/partnerships for and create/manage CARE distribution instructions to the Asset Consolidator & Distributor Module 500 on when and how to re-purpose and distribute the assets it has received and is holding. All components in this module also receive business strategy and information inputs from and provide outputs about their activities and information to the CRM & Business Intelligence Analytics Engine 600 and Consumer Management Modules 800 to create or modify their modules' platforms, partnerships, processes, and instructions. It also receives, facilitates, and acts on instructions from CARE program consumers and their supporters.

According to an embodiment of the present invention, the Asset Distribution Director Module 700 comprises a Consumer Creditor Payment Director Module 702 configured to receive and act on ongoing, business strategy and information inputs from the CRM & Business Intelligence Analytics Engine 600 and Consumer Management Module 800 to formulate, manage, and distribute creditor payment instructions to the Creditor Payment Accounts Module 502. The module regularly instructs the Creditor Payment Accounts Module 502 on when and how to re-purpose, aggregate, and distribute CARE consumer and supporters' payments, earned CARE retailer spending rewards, and other consumer assets for payments to each creditor. It also instructs the module to package the aggregated information and distribute payments to each creditor's Creditor Payments & Consumer Treatments Module 108.

According to an embodiment of the present invention, the Asset Distribution Director Module 700 comprises a CARE Asset Director Module 704 configured to receive and act on ongoing business strategy and information inputs from the CRM & Business Intelligence Analytics Engine 600 and Consumer Management Module 800 to formulate re-purposing, allocation, and distribution instructions for the CARE Asset Accounts Module 504. This module instructs the CARE Retailer Earned Rewards Account 504.1 in the CARE Asset Accounts Module 504 on when and how to re-purpose, segregate, aggregate and re-allocate its assets to the 504.2 through 504.5 sub-accounts within that module, how long to hold them in the sub-accounts, and when and where to distribute the earned reward assets in the sub-accounts.

The CARE Asset Director Module's 704 instructions cover the re-purposing, segregation, aggregation, allocations, and distribution of earned rewards to creditor payments, consumer asset accounts, and return to retailers. Based on the information and strategies it manages, the module sends asset distribution and related information instructions to the Creditor Payment Accounts Module 502, the Consumer Asset Accounts Module 506, and the Retailer Rewards Calculation & Settlement Module 308.

According to an embodiment of the present invention, the Asset Distribution Director Module 700 comprises a Consumer Assets Director Module 706 configured to set up and manage the CARE platform to receive, manage, and distribute CARE program consumers and supporters instructions and payment destination information for re-purposing, allocating, and distributing their assets in the Consumer Asset Accounts Module 506 and the Consumer Transaction Account Module 200. The Consumer Assets Director Module 706 aggregates and integrates the instructions with business strategy, information, and asset restriction outputs from the CRM & Business Intelligence Analytics Engine 600 and the Consumer Management Module 800. It then sends consumer asset re-purposing, allocation, storage, and distribution instructions along with any CARE program restrictions on those instructions to the Consumer Asset Accounts Module 506. CARE program consumers and supporters may change their asset re-purposing, allocation, storage, and distribution instructions at any time, subject to any CARE program restrictions on their asset accounts.

The Consumer Assets Director Module 706 may provide a wide range of options described below for CARE program consumers and their supporters to re-purpose their assets in the Consumer Asset Accounts Module 506 or add direct additional payments to meet CARE program requirements and other needs. Consumers and their supporters in the CARE program for collections/recovery management may have restrictions imposed on any and/or all options described in this module if consumers are in a remediation or terminated status with the CARE program or until they have made significant progress toward or completed their debt settlement repayment programs.

According to an embodiment of the present invention, consumers and their supporters may choose to re-purpose and direct their excess earned CARE retailer rewards or monetized other consumer assets to make additional deposits to the consumers' and/or supporters' Consumer Transaction Accounts 706.1 in the Consumer Transaction Account Module 200. These re-purposed assets and additional payments or deposits can help CARE program consumers meet their minimum monthly CARE payment and necessity spending requirements, accelerate their debt settlement repayment program completion through additional spending, pay bills, or meet other needs.

According to an embodiment of the present invention, consumers and their supporters may choose to re-purpose and direct their excess earned CARE retailer rewards or monetized other consumer assets to make additional payments to the Creditor Payment Account Module 502 to help meet or accelerate debt settlement repayments to creditors using an Additional Creditor Payments Account 706.2. They may also make additional cash deposits to this account and instruct that the deposits be used for additional payments to the Creditor Payment Account Module 502.

According to an embodiment of the present invention, consumers and their supporters may choose to re-purpose and direct their excess earned CARE retailer rewards to make additional payments to the =Creditor Payment Account Module 502 to help meet or accelerate debt settlement repayments to creditors using an Excess Rewards—Not Graduated account 706.3. If there are no restrictions, they may also direct these rewards to other accounts in this module to meet other needs. Consumers and their supporters may choose to re-purpose and direct their monetized other consumer assets to make additional payments to the Creditor Payment Account Module 502 to help meet or accelerate debt settlement repayments to creditors using an Other Monetized Assets account 706.4. If there are no restrictions, they may also direct these rewards to other accounts in this module to meet other needs.

According to an embodiment of the present invention, consumers and their supporters may choose to re-purpose and direct their excess earned CARE retailer rewards or monetized other consumer assets to other accounts in this module to meet other consumer needs using an Earned Rewards—Graduated account 706.5. Consumers and their supporters may choose to re-purpose and direct their assets to pay any of the consumers' and/or supporters' billers through the module's either direct or third party CARE bill payment service utilizing “push” transactions just like any other bill payment service using a Billers account 706.6. Examples of billers include, but are not limited to, water, power, insurance bills, lawn services, mortgage payments, tuition, or any other biller such as are currently set up on bill payment systems in use today for consumers through banks. In addition, the consumers may go directly to a biller's web site and initiate “pull” transactions from CARE Consumer Transaction Accounts, as long as they have sufficient balances in their CARE funding accounts.

According to an embodiment of the present invention, consumers and their supporters may choose to re-purpose and direct their assets to initiate payments on any of the consumers' and/or supporters' other revolving debt loans such as non-CARE program credit cards, home equity or credit lines they may have outstanding through either the “push” or “pull” mechanism using an Other Revolving Debt account 706.7, as described above with respect to the Billers account 706.3.

According to an embodiment of the present invention, consumers and their supporters may choose to re-purpose and direct their assets to initiate payments on any of the consumers' and/or supporters' installment loans they may have outstanding through either the “push” or “pull” mechanism using an Installment Debt account 706.8, as described above with respect to the Billers account 706.3. Some examples include, but are not limited to, car loans, personal loans, medical debt, student loans, or any other installment loans.

According to an embodiment of the present invention, Consumers and their supporters may choose to re-purpose and direct their assets to any of the consumers' and/or supporters' CARE savings accounts at CARE's banking partnership set up by this module or at any other financial institution using either the “push” or “pull” mechanism using a Savings account 706.9, as described above with respect to the Billers account 706.3. Consumers may also establish multiple savings asset accounts for a variety of purposes and have funds transferred in any amounts to any of these accounts and for any desired savings goal(s). Optionally, consumers and supporters may leave savings funds in their savings asset accounts or direct them toward CARE program payments/spending or any other purpose, including directing to their other asset accounts in the Consumer Asset Accounts Module 506.

According to an embodiment of the present invention, as consumers and their supporters recover financially and get closer to graduation from the CARE program for collections/recovery management, they may start to re-purpose and direct their assets to CARE investment accounts through CARE's banking partnership set up by this module or at any other financial institution using an Investments account 706.10. Again, they would continue to use either the “push” or “pull” mechanism, as described above with respect to the Billers account 706.3.

According to an embodiment of the present invention, as consumers and their supporters recover financially and get closer to graduation from the CARE program for collections/recovery management, they may also start to re-purpose and direct their assets toward helping others through charitable donations to any non-profit organization using either the “push” or “pull” mechanism using a Charitable Donations account 706.11, as described above with respect to the Billers account 706.3.

According to an embodiment of the present invention, consumers and their supporters may also choose to start to re-purposing and directing their assets toward helping others by making micro-loans or small peer loans to others through a CARE micro-lending or peer-to-peer partnership set up by this module using either the “push” or “pull” mechanism using a Micro-or-Peer Lending account 706, as described above with respect to the Billers account 706.3.

According to embodiments of the present invention, the CARE System 10 comprises Consumer Management Module 800 configured to set up and manage the CARE platforms, channels, and processes for interacting with, supporting, and managing CARE consumers and supporters throughout their CARE lifecycles. The module works with the Consumer Referral, Screening & Acquisition Module 106, the Supporters Consumer Direct Acquisition Module 100A, and Consumer Eligibility & Debt Repayment Parameters Module 104 and third parties to develop and manage its methods, interfaces, and processing activities. The Consumer Management Module 800 also assigns statuses to and develops/manages CARE treatments of creditors' consumers and other consumers in the CARE program using business strategy and policy outputs from the CRM & Business Intelligence Analytics Engine 600. The Consumer Management Module 800 may regularly reports creditors' consumer statuses to the Creditor Payments & Consumer Treatments Module 108 and the Supporters Acquisition & Other Program Features Module 106A. In addition, all components in this module report their activities and information to the CRM & Business Intelligence Analytics Engine 600.

According to an embodiment of the present invention, the Consumer Management Module 800 may comprise a Platforms & Channels Module 802 configured to set up and manage the CARE platforms, channels, and processes for interacting with, supporting, and managing CARE consumers and supporters throughout their CARE lifecycles. The platforms and channels may include, but are not limited to, the CARE call center, web-based connections, direct mail, mobile and email messaging, telemarketing, social networking, advertising, and public relations, with consumer interaction process customization and operational support infrastructures that best fit each platform and channel. The Platforms & Channels Module 802 may work with third party servicing, risk and compliance screening, technology, and other providers to establish partnerships and contracts that assist in setting up, building, and/or providing platforms and services. These partners also provide information and reporting about their activities and support to CARE.

According to an embodiment of the present invention, the Consumer Management Module 800 may comprise an Acquisition Module 804 configured to provide the consumer interface platforms for and manages referral, sales, applications, risk screening, acquisition, and decline processing activities for consumers and supporters entering the CARE program through the Consumer Referral, Screening & Acquisition Module 106 and the Supporters Consumer Direct Acquisition Module 100A. The Acquisition Module 804 also works with the Consumer Eligibility & Debt Settlement/Repayment Parameters Module 104 and Consumer Referral, Screening & Acquisition Module 106 to develop and manage its methods, interfaces, and processing activities. Consumers in this module are CARE prospects, have an application to CARE in process, are being accepted and acquired into the CARE program, or have been declined for the CARE program.

According to an embodiment of the present invention, the Acquisition Module 804 comprises a Creditor Referrals to CARE sub-module 804.1 communicatively connected to the Consumer Eligibility & Debt Repayment Parameters Module 104 and the Consumer Referral, Screening & Acquisition Module 106 and configured to determine, develop, and manage the methods for pre-screening and referring creditors' eligible consumers to CARE and what and how information about eligible consumers will be transferred to CARE with referrals or for direct marketing. It also determines and develops customization and scripting by channel, prospect tracking through the sales process mechanisms, and other information capture, process, and tracking activities.

According to an embodiment of the present invention, the Acquisition Module 804 comprises a Supporter Referrals to CARE sub-module 804.2 configured to develop the methods, platforms, and support processes used by consumers to refer supporters to the CARE program, such as, for example, warm transfers of CARE program consumer calls to supporters within the CARE call center. It also develops, accepts, and processes applications provided to supporters by CARE program consumers to this module by direct mail and/or web-based online applications.

According to an embodiment of the present invention, the Acquisition Module 804 comprises a_Applications, Risk Screening & Offers sub-module 804.3 configured to provide consumer and supporter interactions, platforms, and processes to take applications; process applications through the CRM & Business Intelligence Analytics Engine 600 for risk screening, approval/denials, and offer terms; follow up with consumers on risk screening exceptions; make offers to consumers; and track applications and offer acceptances. The Applications, Risk Screening & Offers sub-module 804.3 also selects/contracts with third party risk screening and compliance vendors to support this process, and integrates their platforms into other CARE modules.

According to an embodiment of the present invention, the Acquisition Module 804 comprises a Consumer Acquisition sub-module 804.4 configured to support the development and management of fulfillment processes and consumer interactions after gaining agreements for acquisition into the CARE program. Activities include development and distribution of consumer collateral and communications, scripts, customer agreements and terms, program descriptions, and consumer questions and answers for all channels. The Consumer Acquisition sub-module 804.4 also develops and supports notifications to creditors to halt their own collections efforts and additional fees on the consumers' delinquent or charged off debt balances and accept the previously agreed upon debt settlement as payment in full, subject to successful CARE program completion.

According to an embodiment of the present invention, the Acquisition Module 804 comprises a Decline sub-module 804.5 configured to develop the processes, communications, methods, and collateral for notifying and notifies applicants declined for the CARE program. The Decline sub-module 804.5 customizes notifications by channel, and includes reasons for decline, what and whose information was used to make the decline decisions, and contact information for consumers to correct any information they think was provided in error in the notifications. It also reports creditors' consumer declines to the Creditor Payments & Consumer Treatments Module 108.

According to an embodiment of the present invention, the Acquisition Module 804 comprises a Sales, Applications & Acquisition Consumer & Supporters Dispositions sub-module 804.5 configured to move acquired consumers and their supporters to the New Module 806, described below. The Sales, Applications & Acquisition Consumer & Supporters Dispositions sub-module 804.5 also transfers declined creditors' consumers to creditors' Creditor. Payments & Consumer Treatments Modules 108 for placement back into the creditors' collections/recovery processes for the full amount of the original debt.

According to an embodiment of the present invention, the Consumer Management Module 800 may comprise a New Module 806 configured to manage and provide welcome calls and frequent ongoing communications to/performance tracking of consumers in the CARE program for collections/recovery management and family friends who are new to the CARE program to help ensure their understanding and success in the program. The New Module 806 may comprise a Welcome Calls/Packages sub-module 806.1 configured to schedule, make, and manage welcome calls/sends welcome packages to all CARE program consumers shortly after acquisition into the CARE program. The calls/packages help familiarize consumers with and answer their questions about all aspects of the CARE program, CARE necessity spending participating retailers and retailer locations, spending category requirements, and Consumer Transaction Account funding methods, spending, and payment options.

According to an embodiment of the present invention, the New Module 806 comprises a New Customer Ongoing Communications & Monitoring sub-module 806.2 configured to closely monitor consumer spending and payment behavior, and notifies consumers quickly when they veer off track through outgoing calls, SMS mobile messages, emails, and web-based mail. It also encourages consumers to invite supporters into the program and consumers and supporters to monetize other assets to help consumers pay down their debts faster. It also lets supporters know if consumers are veering off track so that they can assist in helping to get consumers quickly back on track.

According to an embodiment of the present invention, the New Module 806 comprises a New Consumer & Supporters Dispositions sub-module 806.3 configured to move new customers in the CARE program for collections/recovery management and their supporters who are acclimated to the CARE program and performing to the Performing Module 808, described below. The New Consumer & Supporters Dispositions sub-module 806.3 moves consumers who are not performing and their supporters to the Remediation Module 810. The New Consumer & Supporters Dispositions sub-module 806.3 may also move consumers (but not their supporters) back to the creditors' Creditor Payments & Consumer Treatments Modules 108 for placement back into the creditors' collections/recovery processes for the full amount of the original debt and forfeit their right to the reduced debt settlement. Supporters of non-performing consumers who have been moved back to the creditors' collections/recovery processes may remain in the program and are moved to the Graduated/Standard Module 816, described below.

According to an embodiment of the present invention, the Consumer Management Module 800 comprises a Performing Module 808 configured to manage and provide incentives, ongoing communications, and debt repayment and personal financial management strategies to consumers in the CARE program for collections/recovery management along with their supporters who are performing—current on monthly payments to CARE and minimum necessity at CARE retailers. The Performing Module 808 may comprise an Incentives sub-module 808.1 configured to provide regular CARE incentives to these consumers, such as adding extra payments to the Creditor Payment Account 502 or providing movie/restaurant and/or other similar gifts to encourage and motivate program completions.

According to an embodiment of the present invention, the Performing Module 808 comprises a Progress Tracking Communications sub-module 808.2 configured to provide regular encouragement to these consumers through progress tracking reports, emails, SMS messages, recognition on the CARE Personal Financial Management Module 906 (described below) and social networking sites, and the like when consumers reach and/or exceed interim repayment milestones.

According to an embodiment of the present invention, the Performing Module 808 comprises a Debt Repayment/PFM Strategies sub-module 808.3 configured to determine and suggest strategies, such as adding to payments every month, boosting necessity spending, monetizing and re-purposing other reward program assets, or inviting supporters into the CARE program, that can help these consumers graduate early from their debt settlement repayment obligations to creditors. The Debt Repayment/PFM Strategies sub-module 808.3 also reminds consumers how they can start re-purposing their earned rewards on spending and other assets toward bill payment, savings, investments, etc. through improved personal financial management using the Personal Financial Management Module 906 when they get closer to satisfying their debt obligations to help sustain their financial recoveries. In addition, it reminds them of the long-term program benefits of restoring their credit histories, as well as the negative consequences if they don't complete the program as agreed.

According to an embodiment of the present invention, the Performing Module 808 comprises a Performing Consumer & Supporters Dispositions sub-module 808.4 configured to move performing consumers who have successfully completed their creditor repayment programs and their supporters to the Graduated/Standard Module 816 (described below), and consumers who are no longer performing and their supporters to the Remediation Module 810. The Remediation Module 810 is configured to manage CARE remediation efforts for consumers in the CARE program for collections/recovery management who have fallen behind on monthly payments to CARE and/or are not spending at least the monthly required minimum amounts on necessities either on their own or in combination with their supporters to get them back on track.

According to an embodiment of the present invention, the Remediation Module 810 comprises a Remediation Outreach Efforts sub-module 810.1 configured to perform a variety of outreach efforts to these consumers, beginning as soon as the consumers start to veer off track. The Remediation Outreach Efforts sub-module 810.1 does outgoing calls to discuss their situations and strategies to get back on track, including boosting their CARE program spending, monetizing and re-purposing other assets, inviting supporters into the CARE program, and better household budgeting and financial management techniques. The Remediation Outreach Efforts sub-module 810.1 also sends regular SMS messages and emails, reiterates the negative consequences of not catching up and staying on track, and sets/tracks/acts on deadlines and missed deadlines for improvement steps.

According to an embodiment of the present invention, the Remediation Module 810 comprises a Remediation CARE Program Adjustments sub-module 810.2 configured to adjust the mix of partial debt payments, minimum spend amount (e.g., necessity spending), and/or the pay-off time period (e.g. number of months) into program terms they are more likely to successfully manage and complete for those consumers who have made significant improvement, but have not yet completely caught back up, this module may. These consumers may be allowed remain in the remediation module for an additional period to ensure they are able to keep current under the adjusted terms.

According to an embodiment of the present invention, the Remediation Module 810 comprises Remediation Consumer & Supporters Dispositions sub-module 810.3 for returning those consumers who are successfully remediated having fully caught up on their monthly payments and/or necessity spending or adjusted program terms, and their supporters, to the Performing Module 808. After a final warning period, consumers who have not remediated and their supporters are sent to the Involuntary Termination Module 812.

According to an embodiment of the present invention, the Consumer Management Module 800 comprises an Involuntary Termination Module 812 configured to terminate consumers in the CARE program for collections/recovery management for continued non-performance after a period of remediation opportunities through the Remediation Module 810. The Involuntary Termination Module 812 also handles the dispositions of their supporters and assets. The Involuntary Termination Module 812 may comprise a Forfeit of CARE Program Benefits sub-module 812.1 configured to manage the process relating to the forfeiture of consumers' rights to the reduced debt settlements with creditors and their/their supporters' current period earned necessity spending rewards. In addition, the Forfeit of CARE Program Benefits sub-module 812.1 may also forfeit assets in the Consumer Asset Accounts Module 506 and direct those assets to the Consumer Creditor Payment Director module 702.

According to an embodiment of the present invention, the Involuntary Termination Module 812 comprises an Involuntary Termination Consumer & Supporters' Dispositions sub-module 812.2 configured to transfer consumers to creditors' Creditor Payments & Consumer Treatments Modules 108 for placement back into the creditors' collections/recovery processes for the full amount of the original debt minus any CARE payments to-date. Supporters may remain in the CARE program, minus any assets forfeited, and are transferred to the Graduated/Standard Module 816.

According to an embodiment of the present invention, the Consumer Management Module 800 comprises a Voluntary Termination Module 814 configured to terminate consumers in the CARE program for collections/recovery management who have been current on CARE program commitments but voluntarily terminate from the CARE program without completing their agreed upon debt settlement repayment obligations to creditors. The Voluntary Termination Module 814 also handles the dispositions of their supporters and assets. The Voluntary Termination Module 814 may comprise a Forfeit of CARE Program Benefits sub-module 814.1 configured to manage the forfeiture of these consumers' rights to the reduced debt settlements with creditors and their/their supporters' current period earned necessity spending rewards. In addition, the module may also forfeit assets in the Consumer Asset Accounts Module 506 and direct those assets to the Consumer Creditor Payment Director Module 702.

According to an embodiment of the present invention, the Voluntary Termination Module 814 comprises a Voluntary Termination Consumer & Supporters Dispositions sub-module 814.2 configured to transfer these consumers to creditors' Creditor Payments & Consumer Treatments Modules 108 for placement back into the creditors' collections/recovery processes for the full amount of the original debt minus any CARE payments to-date. Supporters may remain in the CARE program, minus any assets forfeited, and are transferred to the Graduated/Standard Module 816 configured to graduate consumers and their supporters that have successfully completed the CARE program for collections/recovery management by fully repaying their debt settlement repayment obligations to the creditor.

According to an embodiment of the present invention, the Graduated/Standard Module 816 comprises a Final Creditor Reporting sub-module 816.1 configured to report these consumers' graduations to the creditors' Creditor Payments & Consumer Treatments Module 108. The creditor does final credit reporting on the consumers' debt repayments and may opt to re-extend credit and other products to these consumers. the Graduated/Standard Module 816 may also comprise a Graduated/Standard Consumer & Supporters Dispositions sub-module 816.2 configured to moves these consumers and their supporters out of the CARE program for collections/recovery management into the standard CARE program. Ongoing payments are optional, and the module directs them to their asset accounts in the Consumer Asset Accounts Module 506. If they continue minimum or more monthly necessity spending at CARE retailers, the module directs the same level of earned rewards applied previously to their debt settlement repayments to their asset accounts in the Consumer Asset Accounts Module 506. If their spending declines below the minimum, their level of earned rewards drops proportionately.

Consumers and their supporters may also continue to collect and monetize other assets through the Other Asset Collection & Monetization Module 400, and re-purpose and direct them to Consumer Asset Accounts Module 506. The Graduated/Standard Consumer & Supporters Dispositions sub-module 816.2 may also credit-qualify them for and offer them credit products from the Credit Extension Module 908, described below.

According to an embodiment of the present invention, the CARE System 10 comprises a Derivative Products Module 900 configured to identify opportunities for and creates new, innovative derivative products using business strategy, information, product, testing, scoring, and other inputs and outputs to/from the CRM & Business Intelligence Analytics Engine 600. In this regard, the CARE System 10 provides in-depth, unique view and understanding of the distressed consumers' market and their needs, behaviors, and performance enable new consumer-direct and business-to-business product innovation that fills huge gaps of unmet needs in this large and underserved market. In addition, the CARE System 10 draws upon its business intelligence, analytics, and insights combined with customization flexibility capabilities down to one consumer or one partner to extend derivative product innovation to the broader consumer and business markets.

According to an embodiment of the present invention, the Derivatives Products Module 900 comprises a Behavior Scores Module 902 configured to create and continually improve distressed consumer behavior score products with wide applicability in multiple markets gained from the unique view and understanding of consumers in the CARE program through the CRM & Business Intelligence Analytics Engine 600.

Advantageously, the CARE System 10 has visibility into CARE program users' monthly spending behavior at CARE retailers (category purchases, amounts, retailers, frequency, etc.) and performance against spending commitments. The CARE System 10 sees consumers' funding sources and cash flows for monthly spending and payments, how much they earn in retailer rewards and how they use their excess rewards assets, what non-dollar assets they have made available to re-purpose and monetize, and how and when they distribute those assets (to pay off debt faster, fund spending, savings, etc.). The CARE System 10 builds a repeat, long-term history of on-time or missed payments, how and if consumers use their re-purposed savings from payment reduction to make additional payments or savings, and how/what assets consumers tap to get back on track and how long it takes. In addition, The CARE System 10 builds similar family and friends behavioral histories for different consumer segments and demographics.

The Behavior Scores Module 902 then mines, analyzes, and models this data to create predictive “behavior score” products customized for multiple strategic applications and markets. One example is consumer direct scores which consumers can use to reference and improve their “credit worthiness” in the market place. Others include solicitation, application, account management, and retention scores customized by industry for creditors, phone, insurance, or other companies seeking growth through a new source of consumers, better risk and customer management differentiation and controls, and/or improved profitability. Another behavior score product might target utilities or landlords seeking to make a determination about a thin file client.

The behavior scores produced by the CARE System 10 create new sources of revenue in a wide variety of situations and markets as stand-alone products or in conjunction with other consumer scores, and will increase in value as the CARE consumer data becomes more robust with time. In addition, the CARE System 10 strategically supplements its own data with third party data to increase the value of its behavior score products.

According to an embodiment of the present invention, the Derivatives Products Module 900 comprises a Distressed Consumer Market Analysis Module 904 configured to create and continually improve a unique and powerful analysis product of the distressed consumer market with an understanding of individual consumer behavior, segment behavior and the overall market unparalleled in the industry, targeting multiple companies and industries seeking growth opportunities in this large and underserved market.

According to an embodiment of the present invention, the Derivatives Products Module 900 comprises a Personal Financial Management Tools Module 906 configured to create and continually improve a history of monthly deposit, spending patterns, and asset utilization behavior and management tools/information consumers can use for personal financial management and improvement. In addition, the Derivatives Products Module 900 may comprise a Credit Extension Module 908 configured to create, offer, and continually improve extensions of credit to the CARE System 10 and other consumers in the form of secured or unsecured credit cards or other loan products based on CARE-derived historical consumer behavior patterns and repayments of CARE-negotiated debt settlements with their creditors.

According to an embodiment of the present invention, the Derivatives Products Module 900 comprises a Consumer-Direct Credit History Module 910 configured to collect and build consumer-reported credit histories from underserved or thin-file consumers which can be used to build credit reports and credit scores used by various industries and consumers to screen/qualify these consumers for loans and other products. This product can be used independently or together with CARE behavior scores or other industry risk screening scores and tools. Consumers who contribute information may also get price discounts on usage and product extensions.

According to an embodiment of the present invention, the Derivatives Products Module 900 comprises a Consumer Information Gatekeeper 912 configured to create and continually improves a product that gives consumers control over to whom, how much of, and when their CARE behavioral, personal, and demographic information may be distributed to third parties. As CARE customers become more diverse, and CARE supplements its customer intelligence with third party data, this product will be offered to the broader consumer market.

According to an embodiment of the present invention, the CARE System 10 comprises a Third Party Information & Tools Module 1000 configured to work with a variety of third party information providers to secure information sharing arrangements, information tools, and/or information acquisition contracts to enhance CARE programs and products. Third party information providers include CARE partners, such as, for example, creditors, retailer networks, retailers, risk screening providers, banking product providers, technology providers, and operations providers, as well as other third party information and information tool providers. Information from third party providers is combined with proprietary CARE information and analytics to increase the robustness and value of inputs to and outputs from the CRM & Business Intelligence Analytics Engine Module 600.

According to an embodiment of the present invention, the Third Party Information & Tools Module 1000 may comprise a Creditor Feeds Module 1002 configured to receive creditor strategic partner information feeds about their consumers and collections performance referred to the CARE program. Information may include, but is not limited to, consumer demographics, behavior profiles leading up to delinquencies and losses, external and internal credit and behavior performance scores, collections efforts to-date, delinquent account and other customer asset and loan information, and other information. The Creditor Feeds Module 1002 also receives creditor collections and recovery performance information for comparison to CARE performance to help refine and manage creditor partnerships.

According to an embodiment of the present invention, the Third Party Information & Tools Module 1000 may comprise a Retailer & Retailer Network Feeds Module 1004 configured to receive retailer/retailer network strategic partner information feeds about partnership terms and conditions, local market coverage and online retailer coverage, retailer and retailer network locations, market rollout schedules, CARE consumer purchasing behavior and earned rewards, retailer marketing and customer service performance against SLAs, and other information to help refine and manage retailer partnerships.

According to an embodiment of the present invention, the Third Party Information & Tools Module 1000 may comprise a Risk Screening Vendor Feeds Module 1006 configured to receive information about consumers from credit bureaus (e.g., both traditional and alternative for thin-file bureaus); debit bureaus (e.g. eFunds or Early Warning Services); identity fraud and transaction fraud screening vendors; compliance monitoring vendors; public information bureaus; and the like to aggregate, combine, and use to optimize risk management decisions.

According to an embodiment of the present invention, the Third Party Information & Tools Module 1000 may comprise a Consumer Demographic/Behavior Vendor Feeds Module 1008 configured to receive demographic and profiling information about underserved and struggling consumers from public and private data sources to enhance CARE knowledge about these consumer segments. Sources may include feeds from providers of financial services to the underserved (check cashers, money transmitters, and the like); alternative information bureaus; banking partners; and a variety of other consumer demographic and behavior information providers.

According to an embodiment of the present invention, the Third Party Information & Tools Module 1000 may comprise a Banking Product Partner Feeds Module 1010 configured to receive demographic, consumer profiling and behavior, customer relationship, product, product performance, and other information from banking partners providing CARE product extensions to CARE consumers such as loan, investment, and savings products. In addition, the Third Party Information & Tools Module 1000 may comprise a Technology & Operations Provider Feeds Module 1012 configured to receive consumer and provider performance and information feeds from CARE technology and, operations partners. The range of information includes CARE consumer spending and channel behavior, provider SLA performance, call or website volumes, frequency, and types; operations volumes and types, technology performance, and a variety of other information.

According to an embodiment of the present invention, the Third Party Information & Tools Module 1000 may comprise a Market Research Feeds Module 1014 configured to receive market research feeds (e.g., payment products and markets, underserved or struggling consumers, debt management, loyalty and rewards programs, laws and regulations, etc.) and integrates this information with CARE business strategies. The CARE System 10 begins with the negotiation of a debt settlement arrangement for a distressed consumer and then CARE qualifies the consumer for CARE Consumer Transaction Account. The consumer then loads a prepaid card or maintains linked deposit balances with a committed spending amount to be used in the proprietary CARE necessity spend category retailer network. According to embodiments of the present invention, the electronic card, or card account number is the identifying key presented at the Point of Sale or online to earn retailer funded rewards. In addition, these rewards are on the total purchase volume, except for items where state law or store policy prohibit it, while the conventional UPromise approach focuses only on manufacturer branded item level offers. CARE creates a consumer buying group out of distressed and delinquent consumers and has them commit by contract to high levels of spending dollars (substantially higher than any other debit reward buying group) in order to fulfill their negotiated spending at CARE retailers. The buying group generates sufficient rewards to enable CARE to combine those reward dollars with the consumer's negotiated low payments and forward the monthly payment on the settlement agreement with the creditor. According to an alternative embodiment, the CARE System 10 purchases debt directly from the marketplace with the remaining steps of CARE being the same as above.

One having ordinary skill in the art will appreciate that within the CARE System 10, the CRM & Business Intelligence Analytics Engine 600 comprises the proprietary information, business intelligence, analytics, strategy, policy, and products engine for the CARE System 10. The CRM & Business Intelligence Analytics Engine 600 cross-links, segments, integrates, unifies, and analyzes CARE modules' information and activities and transforms them into a powerful ecosystem of strategies, products, scoring and strategy management tools, and continuous, sophisticated information and feedback loops that powers and improves the CARE System 10 and its modules. The CRM & Business Intelligence Analytics Engine 600 captures, tracks, analyzes, learns from and adapts to, and measures the CARE System's10 modules results. The CRM & Business Intelligence Analytics Engine 600 conducts and supports many small tests and combinations of consumer, product, risk, marketing, and partner strategies and segments to maximize learning and minimize risks and costs. Advantageously, this allows quick ramp of successful new strategies and products and quick exits or course corrections when they are not working. By its nature, therefore, it is continually refurbishing the CARE invention through strategy and product innovation.

Alternative embodiments of the present invention may include additional asset classes (see FIG. 1, Modules 402-406 for examples of such assets) which can be monetized and re-purposed towards consumer payments/spending needs. In addition, the CARE System 10 may be configured to include embodiments involving purchasing debt, acquiring delinquent or non-delinquent consumers directly, acquiring consumers through other strategic partners, and other similar embodiments.

According to an embodiment of the present invention, the CARE System 10 is configured to permit the consumer to continue to collect and repurpose assets, as detailed above, following repayment of the debt settlement amount. According to this embodiment, the consumer may select the manner in which he or she wishes to apply the assets collected following repayment of the debt, including application of the assets to everyday needs such as, for example, bill payment, new or other loan payment, or any other suitable purpose desired by the consumer.

What is claimed is:

1. A method for repayment of a debt between a consumer and a creditor, the method comprising:
establishing a debt settlement amount associated with the debt owed by the consumer to the creditor;
calculating a consumer-earned reward based at least in part on spending by the consumer with the one or more retailers;
receiving a partial debt payment from the consumer;
combining the partial debt payment and the consumer-earned rewards to produce a enhanced payment amount; and
reducing the debt settlement amount by the enhanced payment amount.

2. The method of claim 1, further comprising providing the enhanced payment amount to the creditor in partial or full satisfaction of the debt settlement amount.

3. The method of claim 1, further comprising the steps of:
associating one or more supporters with the consumer; and
calculating a supporter-earned reward based at least in part on spending by the one or more supporters with the one or more retailers.

4. The method of claim 3, wherein the enhanced payment amount further comprises the supporter-earned reward.

5. The method according to claim 1, further comprising the step of establishing a minimum spend amount that the consumer is required to spend in with one or more retailers during a selected time period.

6. The method according to claim 5, wherein the selected time period is monthly.

7. The method of claim 1, further comprising the step of including one or more non-dollar assets associated with the consumer in the enhanced payment amount.

8. The method of claim 1, further comprising the step of repurposing consumer-earned rewards per a selection of the consumer following full repayment of the debt settlement amount.

9. A method for facilitating debt repayment, the method comprising:
registering a plurality of retailers to form a network, wherein each retailer in the network provides rewards to the consumer based at least in part on the consumer spending with the retailer;
facilitating a debt settlement amount between a consumer and a creditor;
tracking rewards provided by one or more of the plurality of retailers to the consumer; and
re-purposing the rewards to satisfy the debt settlement amount.

10. The method of claim 9, wherein the debt settlement payments further comprise supporter earned rewards.

11. The method of claim 9, wherein the debt settlement payments further comprise partial debt payment made by one or more supporters.

12. A method for repayment of a debt between a consumer and a creditor, the method comprising:
establishing a debt settlement amount associated with the debt owed by the consumer to the creditor;
calculating a consumer-earned reward based at least in part on spending by the consumer with the one or more retailers;
receiving a partial debt payment from the consumer;
combining the partial debt payment and the consumer-earned rewards to produce a enhanced payment amount; and
reducing the debt settlement amount by the enhanced payment amount.

13. A system for repayment of a debt between a consumer and a creditor, the system comprising:
a creditor collections management module communicatively connected to the consumer and the creditor, the creditor collections management module configured to:
establish a debt settlement amount associated with the debt owed by the consumer to the creditor, and
receive a partial debt payment from the consumer;
a retailer network and reward asset collection module configured to calculate a consumer-earned reward based at least in part on spending by the consumer with the one or more retailers;
an asset consolidator and distributor module configured to combine the partial debt payment and the consumer-earned rewards to produce a enhanced payment amount; and
an asset distribution director configured to reduce the debt settlement amount by the enhanced payment amount.
